(19) United States
(12) Patent Application Publication
(10) Pub. No.: US 2026/0304104 A1
(43) Pub. Date: Oct. 1, 2026

(54) FIRST NETWORK NODE, SECOND NETWORK NODE, AND METHODS PERFORMED THEREBY FOR HANDLING A FIRST INDICATION

(71) Applicant: Telefonaktiebolaget LM Ericsson (publ), Stockholm (SE)

(72) Inventors: Mohammed Yazid LYAZIDI, London (GB); Qian CHEN, Mölndal (SE); Emre YAVUZ, Stockholm (SE)

(73) Assignee: Telefonaktiebolaget LM Ericsson (publ), Stockholm (SE)

(21) Appl. No.: 19/480,586

(22) PCT Filed: May 8, 2024
(86) PCT No.: PCT/SE2024/050444

§ 371 Date: Oct. 31, 2025

Related U.S. Application Data
(60) Provisional application No. 63/501,427, filed on May 11, 2023.

(51) Int. Cl. H04W 8/24

(52) U.S. Cl. CPC H04W 8/24

(57) ABSTRACT

A method performed by a first network node for handling a first indication. The first network node operates in a communications network and sends a first indication to a second network node operating in the communications network. The first indication indicates that a wireless device is an enhanced Reduced Capability (eRedCap) user equipment.

### TECHNICAL FIELD

The present disclosure relates generally to a first network node and methods performed thereby for handling a first indication. The present disclosure further relates generally to a second network node and methods performed thereby, for handling the first indication.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core Network (5GC). NG may be understood to refer to the interface/reference point between the Radio Access Network (RAN) and the CN in 5G/NR. In a 5G System (5GS), a radio base station in NR may be referred to as a gNB or 5G Node B. An NR User Equipment (UE) may be referred to as an nUE.

### NG-RAN Architecture

The overall 5G RAN (NG-RAN) architecture is depicted in FIG. 1, wherein a gNB with the split architecture is depicted.

The NG architecture may be further described as follows. The NG-RAN 10 may be understood to comprise a set of gNBs 11 connected to the 5G Core Network (5GC) 12 through the NG 13 interface. A gNB 11 may support Frequency Division Duplex (FDD) mode, Time Division Duplex (TDD) mode or dual mode operation. gNBs 11 may be understood to be interconnected through an Xn-C 14 interface. A gNB 11 may consist of a gNB-Central Unit (CU) 15 and gNB-Distributed Units (DUs) 16. A gNB-CU 15 and a gNB-Distributed Unit (DU) 16 may be connected via F1 logical interface 17.

NG, Xn and F1 may be understood to be logical interfaces.

A gNB may also be connected to an LTE eNB via the X2 interface. Another architectural option may be that where an LTE eNB connected to the Evolved Packet Core network may be connected over the X2 interface with a so called en-gNB. The latter may be a gNB not connected directly to a CN and connected via X2 to an eNB for the purpose of performing dual connectivity.

eRedCap In RAN #98-e, the Work Item Description (WID) on Enhanced support of reduced capability NR devices RP-223544 was agreed. An objective of the core part of the Work Item (WI) was described as complexity and/or cost reduction. This comprised as further objectives: a) a further reduced UE complexity in Frequency 1 (FR1) [RAN1, RAN2, RAN4], b) that both 15 Kilo Hertz (kHz) Subcarrier spacing (SCS) and 30 kHz SCS may be supported, c) an aim to define at most one Rel-18 Reduced Capability (RedCap) UE type for further UE complexity reduction and d) that the existing UE capability framework may be used, and changes to capability signalling may be specified only if necessary. By default, all UE capabilities applicable to a Rel-17 RedCap UE may be applicable unless otherwise specified.

The further objective of further reduced UE complexity in FR1 [RAN1, RAN2, RAN4], aimed at UE BroadBand (BB) bandwidth reduction and UE peak data rate reduction. According to the objective of UE BB bandwidth reduction, one further particular objective was to have 5 Mega Hertz (MHz) BB bandwidth only for Physical Downlink Shared CHannel (PDSCH), for both unicast and broadcast, and Physical Uplink Shared CHannel (PUSCH), with 20 MHz Radio Frequency (RF) bandwidth for Uplink (UL) and Downlink (DL). The other physical channels and signals may be still allowed to use a Bandwidth Part (BWP) up to the 20 MHz maximum UE RF+BB bandwidth. Another further particular objective according to the objective of UE BB bandwidth reduction was to support additional separate early indication(s) [RAN1, RAN2]. According to the objective of UE peak data rate reduction, one further particular objective was a relaxation of the constraint (v_{Layers}·Qₘ·f≥4) for peak data rate reduction. The relaxed constraint may be, e.g., 1, instead of 4. The parameters (v_{Layers}, Qₘ, f) may be as in Rel-17 RedCap.

In RAN2 #121, some agreements related to further reduced UE complexity in FR1, e.g., extra Reduced Capability, which may be also referred to, or known, as enhanced Reduced Capability, (eRedCap) were achieved. One agreement was to introduce Msg3/MsgA PUSCH based early indication for Rel-18 eRedCap. It was left For Further Study (FFS) how to implement this in the specification (spec), e.g., new Logical Channel Identifiers (LCIDs) or not. Another agreement was to wait for RAN1 progress to see if there is a need for a Msg1 early indication for eRedCap.

### SUMMARY

As part of the development of embodiments herein, one or more challenges with the existing technology will first be identified and discussed.

To support the objective of eRedCap service access, some network enhancements may need to be introduced. When an NG-RAN node may link a UE being an eRedCap UE from the supported bands, there may be a need to establish methods to signal this indication to other nodes in the network, e.g., Access and Mobility Management Function (AMF), gNB-Distributed Unit (DU), etc. to be used for different purposes, charging policy differentiation paging, etc.

According to the foregoing, it is an object of embodiments herein to improve the handling of eRedCap UE.

According to a first aspect of embodiments herein, the object is achieved by a method, performed by a first network node. The method is for handling a first indication. The first network node operates in a communications network. The first network node sends a first indication to a second network node operating in the communications network. The first indication indicates that a wireless device is an eRedCap user equipment.

According to a second aspect of embodiments herein, the object is achieved by a method, performed by the second network node. The method is for handling the first indication. The second network node operates in the communications network. The second network node receives the first indication from the first network node operating in the communications network. The first indication indicates that the wireless device is an eRedCap user equipment.

According to a third aspect of embodiments herein, the object is achieved by the first network node, configured to perform the method. The first network node is for handling the first indication. The first network node is configured to operate in the communications network. The first network node is configured to send the first indication to the second network node configured to operate in the communications network. The first indication is configured to indicate that the wireless device is an eRedCap user equipment.

According to a fourth aspect of embodiments herein, the object is achieved by the second network node, configured to perform the method. The second network node is for handling the first indication. The second network node is configured to operate in the communications network. The second network node is configured to receive the first indication from the first network node configured to operate in the communications network. The first indication is configured to indicate that the wireless device is an eRedCap user equipment.

By sending the first indication indicating that the wireless device is an eRedCap user equipment, the first network node may allow eRedCap UE type identification by other nodes in the network, such as the second network node e.g., Access and Mobility Management Function (AMF), gNB-Distributed Unit (DU), etc. to be used for different purposes, such as for UE access, policy control and paging purposes.

By receiving the first indication, the second network node may be enabled to determine whether or not the eRedCap capability configured is supported, and if not, inform the first network node accordingly.

If the eRedCap capability configured is supported, the second network node may be enabled to use this information. For example, by being aware of the UE eRedCap type, the second network node may enable possible constraining of eRedCap devices in case differentiations of eRedCap UE may be required by the operator. In another example, the first network node may enable to signal to the second network node that the resources being prepared/allocated for the Handover may be for a NR eRedCap UE. In another example, the first network node may enable the second network node to be aware of the UE being eRedCap UE so that the second network node may be enabled to take the information into account, e.g., decide to either proceed with an N3 tunnel setup or reject a path switch request.

### BRIEF DESCRIPTION OF THE DRAWINGS

Examples of embodiments herein are described in more detail with reference to the accompanying drawings, and according to the following description.

FIG. 1 is a schematic representation depicting an example of an NG-RAN architecture, according to existing methods.

FIG. 2 is a schematic diagram illustrating a communications network, e.g., a wireless communications network, according to different examples of embodiments herein.

FIG. 3 is a flowchart depicting an example of a method performed by a first network node, according to embodiments herein.

FIG. 4 is a flowchart depicting an example of a method performed by a second network node, according to embodiments herein.

FIG. 5 is a signalling depicting an example of a method performed by a first network node and a second network node, according to embodiments herein.

FIG. 6 is a signalling depicting another example of a method performed by a first network node and a second network node, according to embodiments herein.

FIG. 7 is a signalling depicting a further example of a method performed by a first network node and a second network node, according to embodiments herein.

FIG. 8 is a signalling depicting an additional example of a method performed by a first network node and a second network node, according to embodiments herein.

FIG. 9 is a schematic block diagram illustrating two non-limiting examples, a) and b), of a first network node, according to embodiments herein.

FIG. 10 is a schematic block diagram illustrating two non-limiting examples, a) and b), of a second network node, according to embodiments herein.

FIG. 11 is a flowchart depicting an example of a method performed by a first network node, according to examples related to embodiments herein.

FIG. 12 is a flowchart depicting an example of a method performed by a second network node, according to examples related to embodiments herein.

FIG. 13 is a schematic block diagram illustrating an example of a communication system 1300 in accordance with some embodiments.

FIG. 14 is a schematic block diagram illustrating an example of a UE 1400 in accordance with some embodiments.

FIG. 15 is a schematic block diagram illustrating an example of a network node 1500 in accordance with some embodiments.

FIG. 16 is a schematic block diagram illustrating a host 1600, which may be an embodiment of the host 1316 of FIG. 13, in accordance with various aspects described herein.

FIG. 17 is a schematic block diagram illustrating an example of a virtualization environment 1700 in which functions implemented by some embodiments may be virtualized.

FIG. 18 shows a communication diagram of a host 1802 communicating via a network node 1804 with a UE 1806 over a partially wireless connection in accordance with some embodiments.

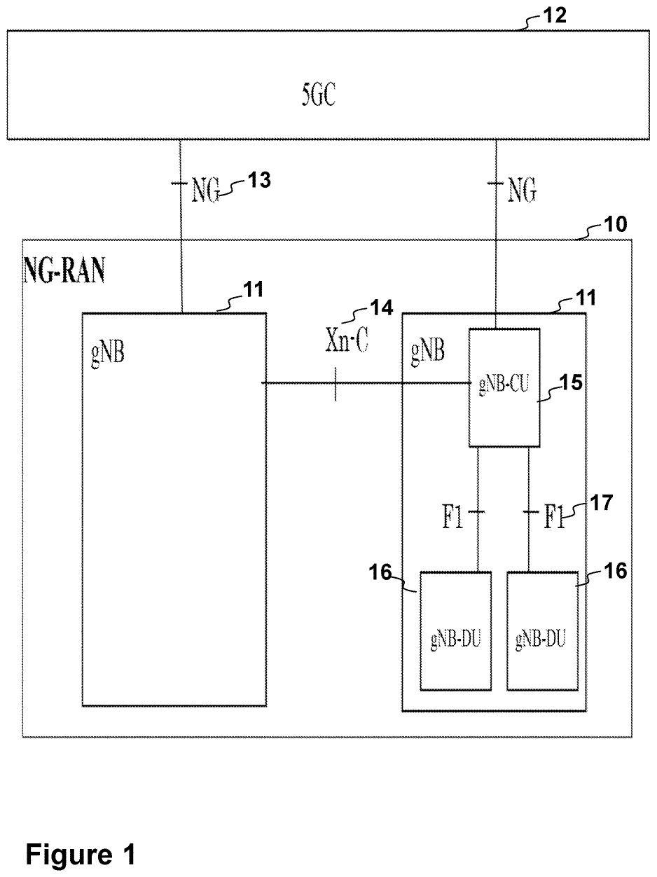

### DETAILED DESCRIPTION

Certain aspects of the present disclosure and their embodiments may provide solutions to the challenge described in the Summary section or other challenges. There are, proposed herein, various embodiments which address one or more of the issues disclosed herein.

Embodiments herein may be understood to be related to methods for signalling eRedCap capability in NG-RAN to 5GCN.

Particular examples of embodiments herein may relate to the following. RAN may enable the awareness of eRedCap UE type of the CN. By being aware of the UE eRedCap type, the CN may enable possible constraining of eRedCap devices in case differentiations of eRedCap UE may be required by the operator. In case of inter Radio Access Technology (RAT) handovers in NG Application Protocol (NG-AP) and Xn Application Protocol (XnAP) specifications, new NR eRedCap indications may be added to signal from target RAN to target AMF that the resources being prepared/allocated for the Handover may be a NR eRedCap UE. In case of F1 paging from gNB-Central Unit (CU) to gNB-DU, an indication of UE being eRedCap UE may be provided for paging purposes.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

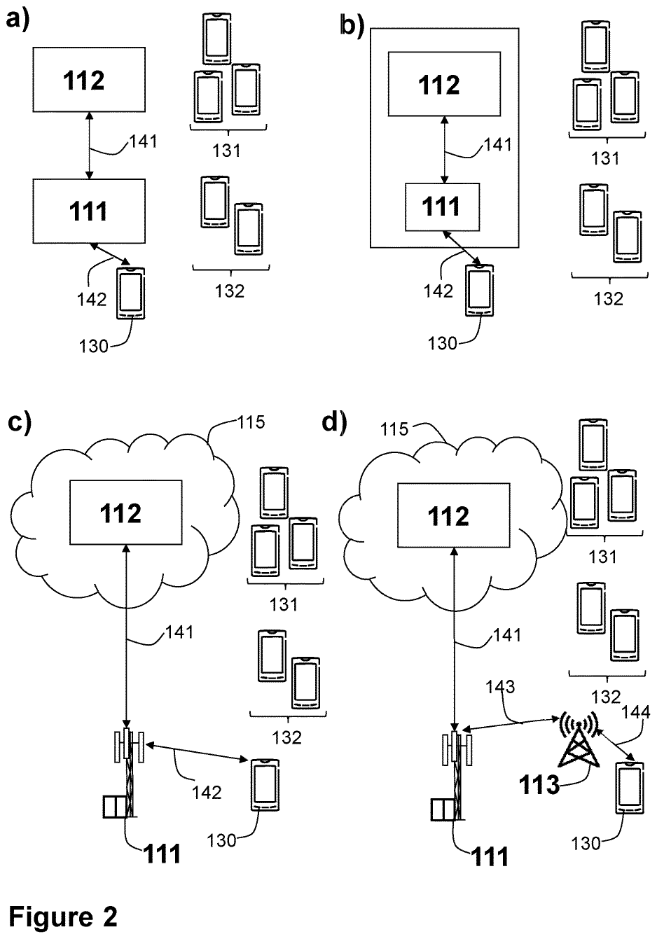

FIG. 2 depicts four non-limiting examples, on panel a), panel b), panel c) and panel d), respectively, of a communications network 100, sometimes also referred to as a communications system, cellular radio system, or cellular network, in which embodiments herein may be implemented. The communications network 100 may be, in some examples, a wireless communications network. The communications network 100 may typically be a 5G system, 5G network, NR-U or Next Gen System or network. The communications network 100 may support a younger system, that is, a newer system, than a 5G system with equivalent functionality. The communications network 100 may support other technologies, such as, for example Long-Term Evolution (LTE), LTE-Advanced/LTE-Advanced Pro, e.g., LTE Frequency Division Duplex (FDD), LTE Time Division Duplex (TDD), LTE Half-Duplex Frequency Division Duplex (HD-FDD), LTE operating in an unlicensed band, etc . . . . Other examples of other technologies the communications network 100 may support may be License-Assisted Access (LAA), Narrow Band Internet of Things (NB-IoT), Machine Type Communication (MTC), MulteFire, Wideband Code Division Multiplexing Access (WCDMA), Universal Terrestrial Radio Access (UTRA) TDD, Global System for Mobile communications (GSM) network, Enhanced Data for GSM Evolution (EDGE) network, GSM/EDGE Radio Access Network (GERAN) network, Ultra-Mobile Broadband (UMB), network comprising of any combination of Radio Access Technologies (RATs) such as e.g., Multi-Standard Radio (MSR) base stations, multi-RAT base stations etc., any 3rd Generation Partnership Project (3GPP) cellular network, WiFi networks, Worldwide Interoperability for Microwave Access (WiMax). Thus, although terminology from 5G/NR and LTE may be used in this disclosure to exemplify embodiments herein, this should not be seen as limiting the scope of the embodiments herein to only the aforementioned systems.

The communications network 100 comprises a first network node 111 and a second network node 112, as depicted in the non-limiting examples FIG. 2. In some embodiments, the communications network 100 may comprise a third network node or source network node 113, as depicted in the non-limiting example of panel d) of FIG. 2. Any of the first network node 111, the second network node 112 and the source network node 113 may be a radio network node. A radio network node may be understood as a transmission point such as a radio base station, for example a gNB, an eNB, or any other network node with similar features capable of serving a wireless device, such as a user equipment or a machine type communication device, in the communications network 100. In particular examples, any of the first network node 111, the second network node 112 and the source network node 113 may be an NG-RAN node. In some embodiments, such as that depicted in panel b) of FIG. 2, the first network node 111 may be a gNB-Centralized Unit (CU) and the second network node 112 may be a gNB-Distributed Unit (gNB-DU). In other embodiments, the second network node 112 may be a core network node. Particularly, the second network node 112 may be an Access and Mobility Management function (AMF). In panel c) of FIG. 2, the first network node 111 is an NG-RAN node and the second network node 112 is a core network node. In panel d), both of the first network node 111 and the source network node 113 are NG-RAN nodes, wherein the first network node 111 is a target network node and the third network node is a source network node 113, and the second network node 112 is a core network node.

In other examples, any of the first network node 111, the second network node 112 and the source network node 113 may be a distributed node, such as a virtual node in the cloud 115, and may perform its functions entirely on the cloud 115, or partially, in collaboration with a radio network node. In the non-limiting examples depicted in panels c) and d) in FIG. 2, the second network node 112 is a network node in the cloud 115.

The communications network 100 may cover a geographical area which may be divided into cell areas, wherein each cell area may be served by a network node, although, one radio network node may serve one or several cells. The communications network 100 may comprise a cell, which is not depicted in FIG. 2 to simplify the Figure. The cell may be served by the first network node 111.

As radio network nodes, any of the first network node 111, the second network node 112 and the source network node 113 may be of different classes, such as, e.g., macro base station, home base station or pico base station, based on transmission power and thereby also cell size. Any of the first network node 111, the second network node 112 and the source network node 113 may support one or several communication technologies, and its name may depend on the technology and terminology used. In 5G/NR, any of the first network node 111, the second network node 112 and the source network node 113 may be referred to as a gNB and may be directly connected to one or more core networks.

The communication network 100 may comprise a plurality of wireless devices, such as a wireless device 130, a first group of wireless devices 131 and a second group of wireless devices 132. In FIG. 2, the first group of wireless devices 131 is depicted as comprising three first wireless devices and the second group of wireless devices 132 is depicted as comprising two second wireless devices. This may be understood to be for illustration purposes only. Each of the first group of wireless devices 131 and the second group of wireless devices 132 may comprise further or fewer wireless devices. Any of the wireless device 130, the first wireless devices in the first group of wireless devices 131 and the second wireless devices in the second group of wireless devices 132 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless device 130, the first wireless devices in the first group of wireless devices 131 and the second wireless devices in the second group of wireless devices 132 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, a sensor, an Internet of Things (IoT) device, or any other radio network unit capable of communicating over a radio link in a communications system. Any of the wireless device 130, the first wireless devices in the first group of wireless devices 131 and the second wireless devices in the second group of wireless devices 132 may be enabled to communicate wirelessly in the communications network 100. The communication may be performed e.g., via a RAN, and possibly the one or more core networks, which may be comprised within the communications network 100. In embodiments herein, the wireless device 130 may be a wireless device with extra reduced capability in comparison with first wireless devices in the first group of wireless devices 131 operating in the communications network 100. The wireless devices in the first group of wireless devices 131 may have reduced capability in further comparison with second wireless devices in the second group of wireless devices 132. The second wireless devices in the second group of wireless devices 132 may be, e.g., wireless devices with normal or standard capability. The first wireless devices in the first group of wireless devices 131 may be RedCap user equipments. The wireless device 130 may be an eRedCap user equipment.

The first network node 111 may be configured to communicate within the communications network 100 with the second network node 112 over a first link 141, e.g., a wired link. The first network node 111 may be configured to communicate within the communications network 100 with the wireless device 130 over a second link 142, e.g., a radio link. The first network node 111 may be configured to communicate within the communications network 100 with the source network node 113 over a third link 143, e.g., a wired link. The source network node 113 may be configured to communicate within the communications network 100 with the wireless device 130 over a fourth link 144, e.g., a wired link or a radio link.

In general, the usage of “first”, “second”, “third” and/or “fourth” herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a first network node, such as the first network node 111, e.g., an NG-RAN node, embodiments related to a second network node, such as the second network node 112, e.g., a core network node, and embodiments related to a third network node such as the source network node 113, e.g., another NG-RAN node.

Some embodiments herein will now be further described with some non-limiting examples.

In the following description, any reference to a/the gNB, NG-RAN node, RAN node, target gNB, and/or gNB-CU, may be understood to equally refer to the first network node 111; any reference to a/the CN, 5GC, core network node, AMF and/or gNB-DU may be understood to equally refer to the second network node 112; any reference to a/the source (ng-) eNB, source network node, source node be understood to equally refer to the source network node 113; reference to a/the UE, a/the eRedCap UE may be understood to equally refer to the wireless device 130; any reference to a/the eRedCap Indication may be understood to equally refer to the first indication; and any reference to a/the cause Information Element (IE) may be understood to equally refer to the second indication.

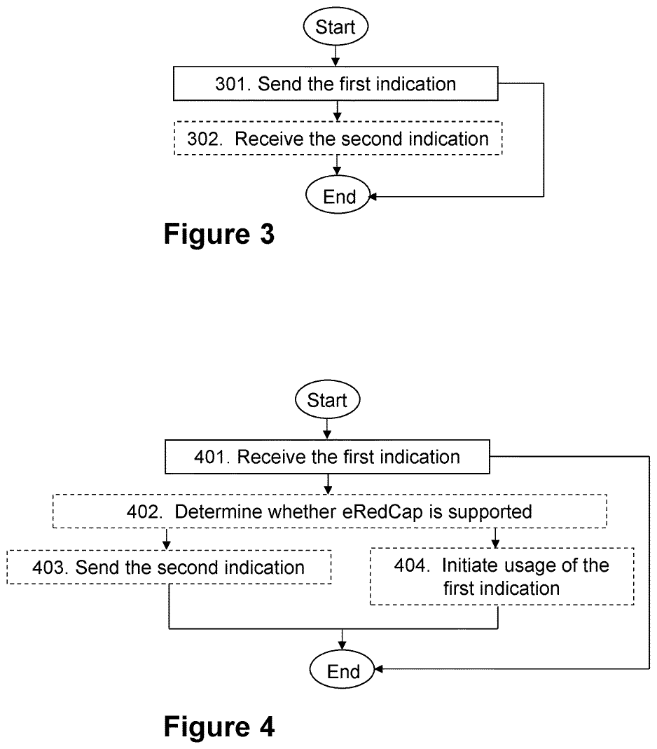

Embodiments of a method, performed by a first network node, such as the first network node 111, will now be described with reference to the flowchart depicted in FIG. 3. The method may be understood to be for handling a first indication. The first network node 111 operates in the communications network 100. The method may be understood to be computer-implemented.

In some embodiments, the first network node 111 may be a first radio network node, the second network node 112 may be a core network node and the source network node 113 may be a second radio network node.

In some embodiments, the first network node 111 may be an NG-RAN node, and the second network node 112 may be an AMF.

In some embodiments, the first network node 111 may be an NG-RAN node, and the second network node 112 may be an NG-eNB.

In some embodiments, the first network node 111 may be a gNB-CU and the second network node 112 may be a gNB-DU.

Several embodiments are comprised herein. In some embodiments all the actions may be performed. In some embodiments, one or more actions may be performed. In particular examples of embodiments herein, Action 301 may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first network node 111 is depicted in FIG. 3. In FIG. 3, optional actions in some embodiments may be represented with dashed lines.

### Action 301

In this Action 301, the first network node 111 sends a first indication.

The sending in this Action 301 is to the second network node 112 operating in the communications network 100, e.g., via the first link 141.

The first indication indicates that the wireless device 130 is an eRedCap user equipment (UE).

In some examples, the first indication may be an eRedCap Indication IE. In some examples, the first indication may be referred to as an eRedCap Indication.

Alternatively, the first indication may be reflected by adding a new codepoint extra reduced capability, also referred to as enhanced reduced capability in the existing information element in 9.3.1.228 RedCap Indication.

The first indication may indicate that the wireless device 130 served by the first network node 111 indicates an extra reduced capability, which may also be referred to as an enhanced reduced capability, in comparison with the first wireless devices in the first group of wireless devices 131 operating in the communications network 100. The first group of wireless devices 131 may have reduced capability in further comparison with the second wireless devices in the second group of wireless devices 132 operating in the communications network 100.

As stated earlier, the second wireless devices in the second group of wireless devices 132 may be, e.g., wireless devices with normal or standard capability. The first wireless devices in the first group of wireless devices 131 may be RedCap user equipments. The wireless device 130 may be an eRedCap user equipment.

In some embodiments, the first network node 111 may be a radio network node and the second network node 112 may be a core network node. In some of such embodiments, the first indication may be sent in one of: an initial UE message, a handover request acknowledge message, and a path switch request.

In some embodiments, e.g., in some of such embodiments, the first network node 111 may be an NG-RAN node and the second network node 112 may be an AMF.

Embodiments herein may provide a method for 5GC, e.g., the second network node 112, to identify the eRedCap UE during initial access and during Evolved UTRA (E-UTRA)/LTE to NR handover and apply proper control in the 5GC as early as possible.

Action 301 may comprise sending an indication, that is, the first indication, from the first network node 111, e.g., a RAN node, to the second network node 112, e.g., a network node in the CN, that the UE is of eRedCap type, by sending a new indication for eRedCap UE in an existing or new NGAP message sent from NG-RAN node to AMF, e.g., NG-AP INITIAL UE MESSAGE.

The Initial UE Message procedure may be used when the first network node 111, e.g., as NG-RAN node, may have received from a radio interface a first uplink Non-Access Stratum (NAS) message to be forwarded to an AMF. The first network node 111, e.g., NG-RAN node, may initiate the procedure by sending an INITIAL UE MESSAGE message to the second network node 112, e.g., AMF. This message may be sent by the first network node 111 to transfer the initial layer 3 message to the second network node 112 over the NG interface. The first network node 111 node may be required to allocate a unique RAN UE NGAP Identifier (ID) to be used for the wireless device 130, and the first network node 111 may be required to include this identity in the INITIAL UE MESSAGE message. If the first indication is included in the INITIAL UE MESSAGE message, the second network node 112 may be required to, if supported, use it according to TS 23.501 [9].

In some embodiments, the first network node 111 may be a first radio network node and the second network node 112 may be a second radio network node. In some of such embodiments, the first indication may be sent in a handover request acknowledge message. In some embodiments, e.g., some of such embodiments, the first network node 111 may be an NG-RAN, node and the second network node 112 may be an NG-eNB.

In some embodiments wherein the first indication may be sent in the handover request acknowledge message, the first network node 111 may be a target network node in a handover procedure. In some embodiments, e.g., some of such embodiments, the first indication may be based on a capability of the wireless device 130 obtained from the source network node 113 in the handover procedure.

In some embodiments, the handover procedure may be an inter-RAT procedure.

The first indication may be sent in a handover request acknowledge message as part of a handover procedure, particularly, a handover resource allocation.

The purpose of the Handover Resource Allocation procedure may be understood to be to reserve resources at the first network node 111, e.g., target NG-RAN node, for the handover of a UE. The procedure may use UE-associated signalling.

The second network node 112, e.g., AMF, may initiate the procedure by sending the HANDOVER REQUEST message to the first network node 111. The HANDOVER REQUEST ACKNOWLEDGE message may be sent by the first network node 111 to inform the second network node 112 about the prepared resources at the target. If the eRedCap Indication IE is included in the HANDOVER REQUEST ACKNOWLEDGE message, according to Action 301, the second network node 112 may be required to, if supported, consider the UE as an eRedCap UE that was previously served by a E-UTRA cell, and use the first indication according to TS 23.501 [9].

Embodiments herein may comprise examples such as follows.

In case of mobility from Evolved Packet System (EPS) to 5GS, the identification and formulation of the eRedCap indication at the first network node 111, e.g., the target gNB, during inter-RAT system Handover (HO) may be as follows. The first network node 111, e.g., a target gNB, may, according to this Action 301, signal the information to the second network node 112, e.g., a CN, that the UE is an eRedCap UE based on the received UE capability information, i.e., the Radio Resource Control (RRC) handover transport container, from the source (ng-) eNB via the exchange messages during inter-RAT handover. From NG-based inter-RAT HO messages: a) a new indication of NR eRedCap UE may be added, according to this Action 301, in the NG-AP HANDOVER REQUEST ACKNOWLEDGE or HANDOVER NOTIFY message from the first network node 111, e.g., the target gNB, towards the second network node 112, e.g., AMF, so that the 5GC may take this information into account; b) the signalling of this eRedCap indication may follow after the first network node 111, e.g., the target NG-RAN, may have inspected the received RRC transport container over NG interface and identified, either explicitly or implicitly, the eRedCap UE information within it; c) in case of rejection, a new cause value, e.g., “eRedCap UE is not supported” may be defined to, according to next Action 302, inform the first network node 111, e.g., the target gNB, of the handover cancellation cause. From Xn-based inter-RAT system HO: a) for Xn handover from an ng-eNB to gNB, a new eRedCap indication may be added, according to this Action 301, in the NG-AP PATH SWITCH REQUEST message from the first network node 111, e.g., the target gNB, to the second network node 112, e.g., the AMF, so that the 5GC may be aware of the UE being eRedCap UE and take the information into account, e.g., decide to either proceed with the N3 tunnel setup or reject the path switch request; b) the signalling of this indication may follow after the first network node 111, e.g., the target NG-RAN, may have inspected the received RRC transport container over Xn interface and identified, either explicitly or implicitly, the eRedCap UE information within it; c) In case of rejection, a new cause value e.g., “eRedCap UE is not supported”, may be defined to inform, according to the next Action 302, the first network node 111, e.g., the target gNB, of the path switch request failure cause. The first network node 111, e.g., the target gNB, may also signal this cause value to the source node, that is, the source network node 113.

The first indication may be sent in a path switch request message as part of a Path Switch Request procedure, particularly, in a Path Switch Request.

The purpose of the Path Switch Request procedure may be understood to be to establish a UE associated signalling connection to the 5GC and, if applicable, to request the switch of the downlink termination point of the NG-U transport bearer towards a new termination point. The procedure may use UE-associated signalling.

The first network node 111, e.g., as a NG-RAN node, may initiate the procedure by sending the PATH SWITCH REQUEST message to the second network node 112, e.g., the AMF. This message may be sent by the first network node 111 to inform the second network node 112 of the new serving NG-RAN node and to transfer some NG-U DL tunnel termination point(s) to the SMF via the second network node 112 for one or multiple PDU session resources. Upon reception of the PATH SWITCH REQUEST message, the second network node 112 may be required to, for each Protocol Data Unit (PDU) session indicated in the PDU Session ID IE, transparently transfer the Path Switch Request Transfer IE to the SMF associated with the concerned PDU session.

When the first network node 111 may have received from the radio interface the RRC Resume Cause IE, it may be required to include it in the PATH SWITCH REQUEST message. If the first indication is included in the PATH SWITCH REQUEST message, the second network node 112 may be required to, if supported, consider the wireless device 130 as an eRedCap UE that was previously served by a E-UTRA cell, and use the first indication according to TS 23.501 [9].

In some embodiments, the first network node 111 may be a gNB-CU, and the second network node 112 may be a gNB-DU. In some embodiments, e.g., some of such embodiments, the first indication may be sent in a paging message.

The first indication may be sent in a paging message as part of Paging Procedure. The purpose of the Paging procedure may be understood to be used to provide the paging information to enable the second network node 112, e.g., a gNB-DU, to page a UE such as the wireless device 130. The procedure may use non-UE associated signalling. The first network node 111, e.g., as a gNB-CU, may initiate the procedure by sending a PAGING message. The first indication may be included in the UE Paging Capability IE in the PAGING message, and if present, the second network node 112 may be required to, if supported, use it for paging of eRedCap UEs. The first indication may provide the UE Paging Capability information that may be needed for paging.

During paging, the first network node 111, e.g., the gNB-CU, that may be aware of the UE being of eRedCap type during the early access, may send, according to Action 301, an indication to the second network node 112, e.g., gNB-DU, over F1 message for paging, to page the UE according to the supporting bands.

### Action 302

In some embodiments, the method may further comprise this action 302. In this Action 302, the first network node 111 may receive a second indication.

The receiving in this Action 302 may be from the second network node 112, e.g., via the first link 141.

The second indication may indicate that eRedCap user equipment is not supported.

The receiving in this Action 302 may be responsive to the sent first indication.

The first network node 111 may then send the second indication to the source network node 113, e.g., via the third link 143.

As mentioned above, in some examples, in case of rejection, a new cause value, e.g., “eRedCap UE is not supported” may be defined to, according to this Action 302, inform the first network node 111, e.g., the target gNB, of the handover cancellation cause, or of the path switch request failure cause. The first network node 111, e.g., the target gNB, may also signal this cause value to the source node, that is, the source network node 113.

The second indication may indicate, in some examples, that the action failed because target NG-RAN node does not support eRedCap UE.

The purpose of the Cause IE may be understood to be to indicate the reason for a particular event for the NGAP protocol. The meaning of the different cause values is described in the tables provided later in this document. In general, “not supported” cause values may indicate that the related capability is missing. On the other hand, “not available” cause values may indicate that the related capability is present, but insufficient resources were available to perform the requested action.

Examples of these actions and the messages and indications are provided later in this document.

Embodiments of a method, performed by a second network node, such as the second network node 112 will now be described with reference to the flowchart depicted in FIG. 4. The method is for handling the first indication. The second network node 112 operates in the communications network 100. The method may be understood to be computer-implemented.

Several embodiments are comprised herein. In some embodiments all the actions may be performed. In some embodiments, one or more actions may be performed. In particular examples of embodiments herein, Action 401 may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second network node 112 is depicted in FIG. 4. The detailed description of some of the following corresponds to the same references provided above, in relation to the actions described for the first network node 111 and will thus not be repeated here to simplify the description. For example, in some embodiments, the first network node 111 may be a first radio network node, the second network node 112 may be a core network node and the source network node 113 may be a second radio network node.

In some embodiments, the first network node 111 may be an NG-RAN node, and the second network node 112 may be an AMF.

In some embodiments, the first network node 111 may be an NG-RAN node, and the second network node 112 may be an NG-eNB.

In some embodiments, the first network node 111 may be a gNB-CU and the second network node 112 may be a gNB-DU.

### Action 401

In this Action 401, the second network node 112 receives the first indication.

The receiving in this Action 401 is from the first network node 111 operating in the communications network 100, e.g., via the first link 141.

The first indication indicates that the wireless device 130 is an eRedCap user equipment.

The first indication may indicate that the wireless device 130 served by the first network node 111 has indicated an extra reduced capability, also referred to as enhanced reduced capability, in comparison with the first wireless devices in the first group of wireless devices 131 operating in the communications network 100. The first group of wireless devices 131 may have reduced capability in further comparison with the second wireless devices in the second group of wireless devices 132 operating in the communications network 100.

In some embodiments, the first network node 111 may be a radio network node and the second network node 112 may be a core network node. In some of such embodiments, the first indication may be received in one of: the initial UE message, the handover request acknowledge message, and the path switch request.

In some embodiments, e.g., in some of such embodiments, the first network node 111 may be an NG-RAN node and the second network node 112 may be an AMF.

In some embodiments, the first network node 111 may be a first radio network node and the second network node 112 may be a second radio network node. In some of such embodiments, the first indication may be received in the handover request acknowledge message. In some embodiments, e.g., some of such embodiments, the first network node 111 may be an NG-RAN, node and the second network node 112 may be an NG-eNB.

In some embodiments wherein the first indication may be received in the handover request acknowledge message, the first network node 111 may be the target network node in a handover procedure. In some embodiments, e.g., some of such embodiments, the first indication may be based on the capability of the wireless device 130 originating from the source network node 113 in the handover procedure.

In some embodiments, the handover procedure may be an inter-RAT procedure.

In some embodiments, the first network node 111 may be a gNB-CU, and the second network node 112 may be a gNB-DU. In some embodiments, e.g., some of such embodiments, the first indication may be received in a paging message.

In some embodiments, the method may comprise one or more of the following actions.

### Action 402

The second network node 112 may determine whether or not the indicated extra reduced capability, also referred to as enhanced reduced capability, is supported.

Particularly, in this Action 402, the second network node 112 may determine whether or not the indicated eRedCap capabability is supported.

Determining may be understood as calculating, deriving, selecting or similar.

The determining in this Action 402 may be responsive to the received first indication.

In some embodiments, the method may further comprise, responsive to the received first indication and based on a result of the determination, one of the following actions.

### Action 403

In this Action 403, the second network node 112 may send the second indication.

The sending in this Action 403 may be to the first network node 111, e.g., via the first link 141.

The second indication may indicate that the eRedCap is not supported.

The second indication may indicate that the extra reduced capability, also referred to as enhanced reduced capability, is not supported.

The sending in this Action 403 may be with the proviso the second network node 112 may determine the eRedCap is not supported. That is, with the proviso the second network node 112 may determine the extra reduced capability, also referred to as enhanced reduced capability, is not supported.

### Action 404

In this Action 404, the second network node 112 may initiate usage of the first indication.

Initiating may be understood as triggering, enabling, starting or facilitating.

The initiating in this Action 404 may be with the proviso the second network node 112 may determine the eRedCap is supported. That is, with the proviso the second network node 112 may determine the extra reduced capability, also referred to as enhanced reduced capability, is supported.

In some embodiments, the usage of the first indication may be in a value indicating a Radio Access Technology (RAT) type. The usage of the first indication in the value may be to identify the RAT type of the wireless device 130.

In some embodiments, the value indicating the RAT type may be a new value.

In other embodiments, the value indicating the RAT type may be an existing value.

When 5GC, e.g., the second network node 112, e.g., AMF, may receive the eRedCap UE indication in Action 401, the 5GC may use a new RAT type value, e.g., NR eRedCap, to identify the RAT type of the wireless device 130. The new RAT type may be used by different network entities, e.g., Session Management Function (SMF), Policy Control Function (PCF), Charging Function (CHF) to differentiate the handling of the eRedCap UE. The 5GC, e.g., the second network node 112, may also use an existing RAT type value, e.g., NR_RedCap, to identify the RAT type of the UE based on operator policy, e.g., if no differentiation of the eRedCap is required.

Examples of these actions and the messages and indications are provided next.

Without loss of generality, below is an example of implementation of the above embodiments to TS 38.413, v. 17.4.0. The changes that would be implemented in TS 38.413, v. 17.4.0 are indicated in bold, underlined font. The first indication is referred to as the eRedCap Indication IE.

### <Start of Changes>

### Initial Ue Message Procedure=

### 8.6.1 Initial UE Message

### 8.6.1.1 General

The Initial UE Message procedure may be used when the NG-RAN node may have received from the radio interface the first uplink Non-Access Stratum (NAS) message to be forwarded to an AMF.

### 8.6.1.2 Successful Operation

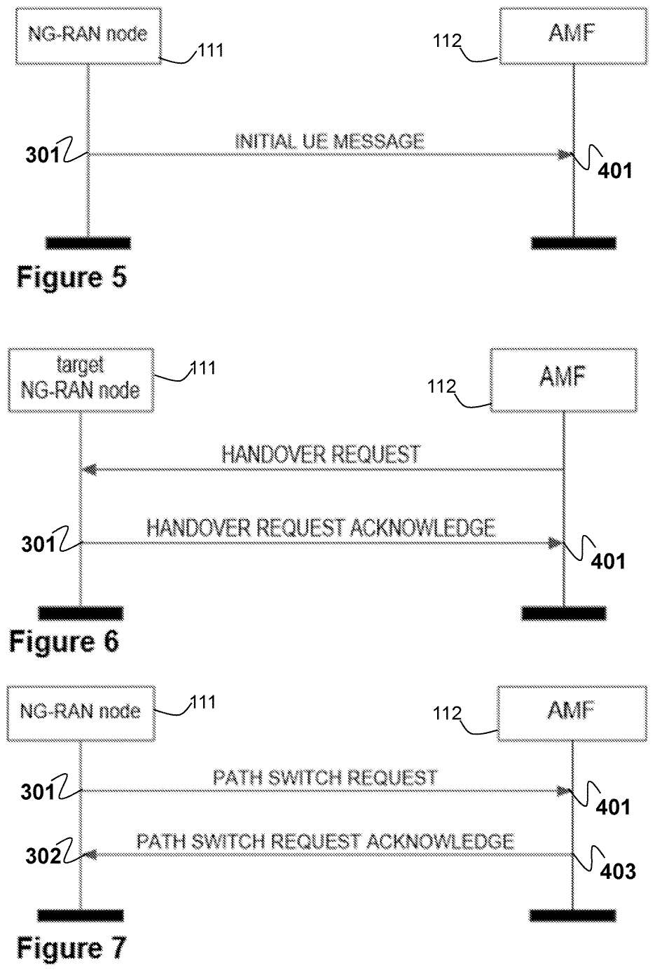

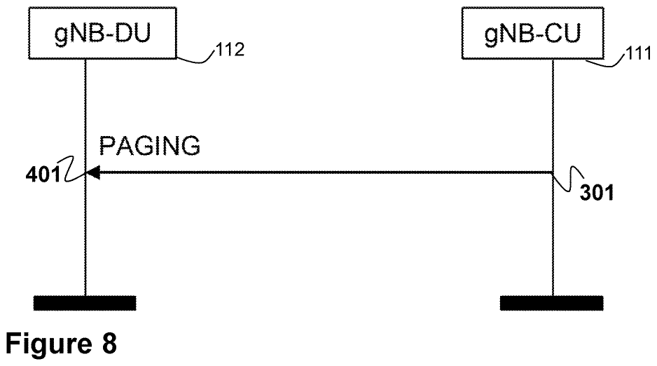

FIG. 5 is a schematic diagram illustrating Initial UE message according to FIG. 8.6.1.2-1. As depicted, the first node 111, an NG-RAN node, may, according to Action 301, send the first indication in an INITIAL UE MESSAGE to the second network node 112, an AMF, which may receive it according to Action 401.

The NG-RAN node may initiate the procedure by sending an INITIAL UE MESSAGE message to the AMF. The NG-RAN node may be required to allocate a unique RAN UE NGAP ID to be used for the UE and the NG-RAN node may be required to include this identity in the INITIAL UE MESSAGE message.
//skipped text unchanged
   If the eRedCap Indication IE is included in the INITIAL UE MESSAGE message, the AMF may be required to, if supported, use it according to TS 23.501 [9].

### Handover Procedure

### 8.4.2 Handover Resource Allocation

### 8.4.2.1 General

The purpose of the Handover Resource Allocation procedure may be understood to be to reserve resources at the target NG-RAN node for the handover of a UE. The procedure may use UE-associated signalling.

### Successful Operation

FIG. 6 is a schematic diagram illustrating Handover resource allocation: successful operation according to FIG. 8.4.2.2-1. As depicted, the first node 111, a target NG-RAN node, may receive a HANDOVER REQUEST message from the second network node 112, an AMF, and in response, according to Action 301, may send the first indication in a HANDOVER REQUEST ACKNOWLEDGE message to the second network node 112, which may receive it according to Action 401.

The AMF may initiate the procedure by sending the HANDOVER REQUEST message to the target NG-RAN node.
//skipped text unchanged
   If the eRedCap Indication IE is included in the HANDOVER REQUEST ACKNOWLEDGE message, the AMF may be required to, if supported, consider the UE as an eRedCap UE that was previously served by a E-UTRA cell, and use the IE according to TS 23.501 [9].

### Path Switch Request Procedure

### 8.4.4 Path Switch Request

### 8.4.4.1 General

The purpose of the Path Switch Request procedure may be understood to be to establish a UE associated signalling connection to the 5GC and, if applicable, to request the switch of the downlink termination point of the NG-U transport bearer towards a new termination point. The procedure may use UE-associated signalling.

### 8.4.4.2 Successful Operation

FIG. 7 is a schematic diagram illustrating Path switch request: successful operation according to FIG. 8.4.4.2-1. As depicted, the first node 111, an NG-RAN node, may, according to Action 301, send the first indication in a PATH SWITCH REQUEST message to the second network node 112, an AMF, which may receive it according to Action 401. The second network node 112 may then send a PATH SWITCH REQUEST ACKNOWLEDGE message to the first network node 111 in accordance with Action 403 and Action 302.

The NG-RAN node may initiate the procedure by sending the PATH SWITCH REQUEST message to the AMF. Upon reception of the PATH SWITCH REQUEST message the AMF may be required to, for each PDU session indicated in the PDU Session ID IE, transparently transfer the Path Switch Request Transfer IE to the SMF associated with the concerned PDU session.

When the NG-RAN node may have received from the radio interface the RRC Resume Cause IE, it may be required to include it in the PATH SWITCH REQUEST message.

If the eRedCap Indication IE is included in the PATH SWITCH REQUEST message, the AMF may be required to, if supported, consider the UE as an eRedCap UE that was previously served by a E-UTRA cell, and use the IE according to TS 23.501 [9].

### Tabular Examples

### 9.2.3.5 Handover Request Acknowledge

This message may be sent by the target NG-RAN node to inform the AMF about the prepared resources at the target.
Direction: NG-RAN node→AMF.

| | | | IE type | | | |
|---|---|---|---|---|---|---|
| IE/Group | | | and | Semantics | | Assigned |
| Name | Presence | Range | reference | description | Criticality | Criticality |
| Message Type | M | | 9.3.1.1 | | YES | reject |
| AMF UE NGAP | M | | 9.3.3.1 | | YES | ignore |
| ID | | | | | | |
| RAN UE NGAP | M | | 9.3.3.2 | Allocated at | YES | ignore |
| ID | | | | the target | | |
| | | | | NG-RAN | | |
| | | | | node. | | |
| PDU Session | | 1 | | | YES | ignore |
| Resource | | | | | | |
| Admitted List | | | | | | |
| >PDU | | 1 . . . | | | — | |
| Session | | <maxnoofPDUSessions> | | | | |
| Resource | | | | | | |
| Admitted | | | | | | |
| Item | | | | | | |
| >>PDU | M | | 9.3.1.50 | | — | |
| Session ID | | | | | | |
| >>Handover | M | | OCTET | Containing | — | |
| Request | | | STRING | the | | |
| Acknowledge | | | | Handover | | |
| Transfer | | | | Request | | |
| | | | | Acknowledge | | |
| | | | | Transfer IE | | |
| | | | | specified in | | |
| | | | | subclause | | |
| | | | | 9.3.4.11. | | |
| PDU Session | | 0 . . . 1 | | | YES | ignore |
| Resource | | | | | | |
| Failed to | | | | | | |
| Setup List | | | | | | |
| >PDU | | 1 . . . | | | — | |
| Session | | <maxnoofPDUSessions> | | | | |
| Resource | | | | | | |
| Failed to | | | | | | |
| Setup Item | | | | | | |
| >>PDU | M | | 9.3.1.50 | | — | |
| Session ID | | | | | | |
| >>Handover | M | | OCTET | Containing | — | |
| Resource | | | STRING | the | | |
| Allocation | | | | Handover | | |
| Unsuccessful | | | | Resource | | |
| Transfer | | | | Allocation | | |
| | | | | Unsuccessful | | |
| | | | | Transfer IE | | |
| | | | | specified in | | |
| | | | | subclause | | |
| | | | | 9.3.4.19. | | |
| Target to | M | | 9.3.1.21 | | YES | reject |
| Source | | | | | | |
| Transparent | | | | | | |
| Container | | | | | | |
| Criticality | O | | 9.3.1.3 | | YES | ignore |
| Diagnostics | | | | | | |
| NPN Access | O | | 9.3.3.46 | | YES | reject |
| Information | | | | | | |
| RedCap | O | | 9.3.1.228 | | YES | ignore |
| Indication | | | | | | |
| eRedCap | O | | 9.3.1.XXX | | YES | ignore |
| Indication | | | | | | |

| Range bound | Explanation |
|---|---|
| maxnoofPDUSessions | Maximum no. of PDU sessions allowed towards one UE. Value is |
| | 256. |

### 9.2.3.8 Path Switch Request

This message may be sent by the NG-RAN node to inform the AMF of the new serving NG-RAN node and to transfer some NG-U DL tunnel termination point(s) to the SMF via the AMF for one or multiple PDU session resources.
Direction: NG-RAN node→AMF.

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| Type | | | | | | |
| RAN UE | M | | 9.3.3.2 | | YES | reject |
| NGAP ID | | | | | | |
| Source | M | | AMF UE | | YES | reject |
| AMF UE | | | NGAP ID | | | |
| NGAP ID | | | 9.3.3.1 | | | |
| User | M | | 9.3.1.16 | | YES | ignore |
| Location | | | | | | |
| Information | | | | | | |
| UE | M | | 9.3.1.86 | | YES | ignore |
| Security | | | | | | |
| Capabilities | | | | | | |
| PDU | | 1 | | | YES | reject |
| Session | | | | | | |
| Resource | | | | | | |
| to be | | | | | | |
| Switched | | | | | | |
| in | | | | | | |
| Downlink | | | | | | |
| List | | | | | | |
| >PDU | | 1 . . . | | | — | |
| Session | | <maxnoofPDUSessions> | | | | |
| Resource | | | | | | |
| to be | | | | | | |
| Switched | | | | | | |
| in | | | | | | |
| Downlink | | | | | | |
| Item | | | | | | |
| >>PDU | M | | 9.3.1.50 | | — | |
| Session | | | | | | |
| ID | | | | | | |
| >>Path | M | | OCTET | Containing | | |
| Switch | | | STRING | the Path | | |
| Request | | | | Switch | | |
| Transfer | | | | Request | | |
| | | | | Transfer IE | | |
| | | | | specified in | | |
| | | | | subclause | | |
| | | | | 9.3.4.8. | | |
| PDU | | 0 . . . 1 | | | YES | ignore |
| Session | | | | | | |
| Resource | | | | | | |
| Failed to | | | | | | |
| Setup List | | | | | | |
| >PDU | | 1 . . . | | | — | |
| Session | | <maxnoofPDUSessions> | | | | |
| Resource | | | | | | |
| Failed to | | | | | | |
| Setup | | | | | | |
| Item | | | | | | |
| >>PDU | M | | 9.3.1.50 | | — | |
| Session | | | | | | |
| ID | | | | | | |
| >>Path | M | | OCTET | Containing | — | |
| Switch | | | STRING | the Path | | |
| Request | | | | Switch | | |
| Setup | | | | Request | | |
| Failed | | | | Setup | | |
| Transfer | | | | Failed | | |
| | | | | Transfer IE | | |
| | | | | specified in | | |
| | | | | subclause | | |
| | | | | 9.3.4.15. | | |
| RRC | O | | RRC | | YES | ignore |
| Resume | | | Establishment | | | |
| Cause | | | Cause | | | |
| | | | 9.3.1.111 | | | |
| RedCap | O | | 9.3.1.228 | | YES | ignore |
| Indication | | | | | | |
| eRedCap | O | | 9.3.1.XXX | | YES | ignore |
| Indication | | | | | | |

| Range bound | Explanation |
|---|---|
| maxnoofPDUSessions | Maximum no. of PDU sessions allowed towards one UE. Value is |
| | 256. |

### 9.2.5.1 Initial Ue Message

This message may be sent by the NG-RAN node to transfer the initial layer 3 message to the AMF over the NG interface.
Direction: NG-RAN node→AMF

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | ignore |
| RAN UE NGAP ID | M | 9.3.3.2 | | YES | reject |
| NAS-PDU | M | 9.3.3.4 | | YES | reject |
| User Location | M | 9.3.1.16 | | YES | reject |
| Information | | | | | |
| RRC Establishment | M | 9.3.1.111 | | YES | ignore |
| Cause | | | | | |
| 5G-S-TMSI | O | 9.3.3.20 | | YES | reject |
| AMF Set ID | O | 9.3.3.12 | | YES | ignore |
| UE Context Request | O | ENUMERATED | | YES | ignore |
| | | (requested, . . . ) | | | |
| Allowed NSSAI | O | 9.3.1.31 | | YES | reject |
| Source to Target | O | 9.3.3.27 | | YES | ignore |
| AMF Information | | | | | |
| Reroute | | | | | |
| Selected PLMN | O | PLMN Identity | Indicates the | YES | ignore |
| Identity | | 9.3.3.5 | selected PLMN | | |
| | | | id for the non- | | |
| | | | 3GPP access. | | |
| IAB Node Indication | O | ENUMERATED | Indication of an | YES | reject |
| | | (true, . . . ) | IAB node | | |
| CE-mode-B Support | O | 9.3.1.156 | | YES | reject |
| Indicator | | | | | |
| LTE-M Indication | O | 9.3.1.157 | | YES | ignore |
| EDT Session | O | ENUMERATED | | YES | ignore |
| | | (true, . . . ) | | | |
| Authenticated | O | ENUMERATED | Indicates the | YES | ignore |
| Indication | | (true, . . . ) | FN-RG has | | |
| | | | been | | |
| | | | authenticated | | |
| | | | by the access | | |
| | | | network. | | |
| NPN Access | O | 9.3.3.46 | | YES | reject |
| Information | | | | | |
| RedCap Indication | O | 9.3.1.228 | | YES | ignore |
| eRedCap | O | 9.3.1.XXX | | YES | ignore |
| Indication | | | | | |

9.3.1.X eRedCap Indication

This IE is provided by the NG-RAN node to inform that the UE indicates extra Reduced Capability.

| | | | | |
|---|---|---|---|---|
| | | | IE type and | |
| IE/Group Name | Presence | Range | reference | Semantics description |

| | | |
|---|---|---|
| eRedCap Indication | M | ENUMERATED |
| | | (eRedCap, . . . ) |

cause value for failure case=

### 9.3.1.2 Cause

The purpose of the Cause IE may be understood to be to indicate the reason for a particular event for the NGAP protocol.

| | | | | |
|---|---|---|---|---|
| | | | | Semantics |
| IE/Group Name | Presence | Range | IE type and reference | description |

| | | |
|---|---|---|
| CHOICE Cause Group | M | |
| >Radio Network Layer | | |
| >>Radio Network | | |
| Layer Cause | M | ENUMERATED |
| | | (Unspecified, |
| | | TXnRELOCOverall expiry, |
| | | Successful handover, |
| | | Release due to NG-RAN |
| | | generated reason, |
| | | Release due to 5GC generated |
| | | reason, |
| | | Handover cancelled, |
| | | Partial handover, |
| | | Handover failure in target |
| | | 5GC/NG-RAN node or target |
| | | system, |
| | | Handover target not allowed, |
| | | TNGRELOCoverall expiry, |
| | | TNGRELOCprep expiry, |
| | | Cell not available, |
| | | Unknown target ID, |
| | | No radio resources available in |
| | | target cell, |
| | | Unknown local UE NGAP ID, |
| | | Inconsistent remote UE NGAP |
| | | ID, |
| | | Handover desirable for radio |
| | | reasons, |
| | | Time critical handover, |
| | | Resource optimisation handover, |
| | | Reduce load in serving cell, |
| | | User inactivity, |
| | | Radio connection with UE lost, |
| | | Radio resources not available, |
| | | Invalid QoS combination, |
| | | Failure in the radio interface |
| | | procedure, |
| | | Interaction with other procedure, |
| | | Unknown PDU Session ID, |
| | | Unknown QoS Flow ID, |
| | | Multiple PDU Session ID |
| | | Instances, |
| | | Multiple QoS Flow ID Instances, |
| | | Encryption and/or integrity |
| | | protection algorithms not |
| | | supported, |
| | | NG intra-system handover |
| | | triggered, |
| | | NG inter-system handover |
| | | triggered, |
| | | Xn handover triggered, |
| | | Not supported 5QI value, |
| | | UE context transfer, |
| | | IMS voice EPS fallback or RAT |
| | | fallback triggered, |
| | | UP integrity protection not |
| | | possible, |
| | | UP confidentiality protection not |
| | | possible, |
| | | Slice(s) not supported, |
| | | UE in RRC_INACTIVE state not |
| | | reachable, |
| | | Redirection, |
| | | Resources not available for the |
| | | slice(s), |
| | | UE maximum integrity protected |
| | | data rate reason, |
| | | Release due to CN-detected |
| | | mobility, |
| | | . . . , N26 interface not available, |
| | | Release due to pre-emption, |
| | | Multiple Location Reporting |
| | | Reference ID Instances, |
| | | RSN not available for the UP, |
| | | NPN access denied, |
| | | CAG only access denied, |
| | | Insufficient UE Capabilities, |
| | | RedCap UE not supported, |
| | | Unknown MBS Session ID, |
| | | Indicated MBS Session Area |
| | | Information not served by the |
| | | gNB, |
| | | Inconsistent slice info for the |
| | | session, |
| | | Misaligned association for the |
| | | multicast and unicast sessions or |
| | | flows, eRedCap UE not |
| | | supported) |
| >Transport Layer | | |
| >>Transport Layer | M | ENUMERATED |
| Cause | | (Transport resource unavailable, |
| | | Unspecified, |
| | | . . . ) |
| >NAS | | |
| >>NAS Cause | M | ENUMERATED |
| | | (Normal release, |
| | | Authentication failure, |
| | | Deregister, |
| | | Unspecified, |
| | | . . . , UE not in PLMN serving |
| | | area) |
| >Protocol | | |
| >>Protocol Cause | M | ENUMERATED |
| | | (Transfer syntax error, |
| | | Abstract syntax error (reject), |
| | | Abstract syntax error (ignore and |
| | | notify), |
| | | Message not compatible with |
| | | receiver state, |
| | | Semantic error, |
| | | Abstract syntax error (falsely |
| | | constructed message), |
| | | Unspecified, |
| | | . . . ) |
| >Miscellaneous | | |
| >>Miscellaneous | M | ENUMERATED |
| Cause | | (Control processing overload, |
| | | Not enough user plane |
| | | processing resources, |
| | | Hardware failure, |
| | | O&M intervention, |
| | | Unknown PLMN or SNPN, |
| | | Unspecified, |
| | | . . . ) |

The meaning of the different cause values is described in the following tables. In general, “not supported” cause values may indicate that the related capability is missing. On the other hand, “not available” cause values may indicate that the related capability is present, but insufficient resources were available to perform the requested action.

| Radio Network Layer cause | Meaning |
|---|---|
| Unspecified | Sent for radio network layer cause when none of the specified |
| | cause values applies. |
| TXnRELOCOverall expiry | The timer guarding the handover that takes place over Xn has |
| | abnormally expired. |
| Successful handover | Successful handover. |
| Release due to NG-RAN | Release is initiated due to NG-RAN generated reason. |
| generated reason | |
| Release due to 5GC | Release is initiated due to 5GC generated reason. |
| generated reason | |
| Handover cancelled | The reason for the action is cancellation of Handover. |
| Partial handover | Provides a reason for the handover cancellation. The HANDOVER |
| | COMMAND message from AMF contained PDU Session Resource |
| | to Release List IE or QoS flow to Release List and the source NG- |
| | RAN node estimated service continuity for the UE would be better |
| | by not proceeding with handover towards this particular target NG- |
| | RAN node. |
| Handover failure in target | The handover failed due to a failure in target 5GC/NG-RAN node or |
| 5GC/NG-RAN node or target | target system. |
| system | |
| Handover target not allowed | Handover to the indicated target cell is not allowed for the UE in |
| | question. |
| TNG_{RELOCoverall} expiry | The reason for the action is expiry of timer TNG_{RELOCoverall}. |
| TNG_{RELOCprep} expiry | Handover Preparation procedure is cancelled when timer |
| | TNG_{RELOCprep} expires. |
| Cell not available | The concerned cell is not available. |
| Unknown target ID | Handover rejected because the target ID is not known to the AMF. |
| No radio resources available | Load on target cell is too high. |
| in target cell | |
| Unknown local UE NGAP ID | The action failed because the receiving node does not recognise |
| | the local UE NGAP ID. |
| Inconsistent remote UE NGAP | The action failed because the receiving node considers that the |
| ID | received remote UE NGAP ID is inconsistent. |
| Handover desirable for radio | The reason for requesting handover is radio related. |
| reasons | |
| Time critical handover | Handover is requested for time critical reason i.e.; this cause value |
| | is reserved to represent all critical cases where the connection is |
| | likely to be dropped if handover is not performed. |
| Resource optimisation | The reason for requesting handover is to improve the load |
| handover | distribution with the neighbour cells. |
| Reduce load in serving cell | Load on serving cell needs to be reduced. When applied to |
| | handover preparation, it indicates the handover is triggered due to |
| | load balancing. |
| User inactivity | The action is requested due to inactivity on all user data radio |
| | bearers (i.e., DRBs and, if applicable, MRBs as per section |
| | 16.10.5.2 in TS 38.300 [8]), e.g., NG is requested to be released in |
| | order to optimise the radio resources. For L2 U2N Relay UE, this |
| | action is requested due to user inactivity on all PDU sessions of L2 |
| | U2N Relay UE and its served remote UE(s). |
| Radio connection with UE lost | The action is requested due to losing the radio connection to the |
| | UE. |
| Radio resources not available | No requested radio resources are available. |
| Invalid QoS combination | The action was failed because of invalid QoS combination. |
| Failure in the radio interface | Radio interface procedure has failed. |
| procedure | |
| Interaction with other | The action is due to an ongoing interaction with another procedure. |
| procedure | |
| Unknown PDU Session ID | The action failed because the PDU Session ID is unknown in the |
| | NG-RAN node. |
| Unknown QoS Flow ID | The action failed because the QoS Flow ID is unknown in the NG- |
| | RAN node. |
| Multiple PDU Session ID | The action failed because multiple instance of the same PDU |
| instances | Session had been provided to/from the NG-RAN node. |
| Multiple QoS Flow ID | The action failed because multiple instances of the same QoS flow |
| instances | had been provided to the NG-RAN node. |
| Encryption and/or integrity | The NG-RAN node is unable to support any of the encryption |
| protection algorithms not | and/or integrity protection algorithms supported by the UE. |
| supported | |
| NG intra-system handover | The action is due to a NG intra-system handover that has been |
| triggered | triggered. |
| NG inter-system handover | The action is due to a NG inter-system handover that has been |
| triggered | triggered. |
| Xn handover triggered | The action is due to an Xn handover that has been triggered. |
| Not supported 5QI value | The QoS flow setup failed because the requested 5QI is not |
| | supported. |
| UE context transfer | The action is due to a UE resumes from the NG-RAN node different |
| | from the one which sent the UE into RRC_INACTIVE state. |
| IMS voice EPS fallback or | The setup of QoS flow is failed due to EPS fallback or RAT fallback |
| RAT fallback triggered | for IMS voice using handover or redirection. |
| UP integrity protection not | The PDU session cannot be accepted according to the required |
| possible | user plane integrity protection policy. |
| UP confidentiality protection | The PDU session cannot be accepted according to the required |
| not possible | user plane confidentiality protection policy. |
| Slice(s) not supported | Slice(s) not supported. |
| UE in RRC_INACTIVE state | The action is requested due to RAN paging failure. |
| not reachable | |
| Redirection | The release is requested due to inter-system redirection or intra- |
| | system redirection. |
| Resources not available for | The requested resources are not available for the slice(s). |
| the slice(s) | |
| UE maximum integrity | The request is not accepted in order to comply with the maximum |
| protected data rate reason | data rate for integrity protection supported by the UE. |
| Release due to CN-detected | The context release is requested by the AMF because the UE is |
| mobility | already served by another CN node (same or different system), or |
| | another NG interface of the same CN node. |
| N26 interface not available | The action failed due to a temporary failure of the N26 interface. |
| Release due to pre-emption | Release is initiated due to pre-emption. |
| Multiple Location Reporting | The action failed because multiple areas of interest are set with the |
| Reference ID Instances | same Location Reporting Reference ID. |
| RSN not available for the UP | The redundant user plane resources indicated by RSN are not |
| | available. |
| NPN access denied | Access was denied, or release is requested, for NPN reasons. |
| CAG only access denied | Access was denied because the cell is a non-CAG cell and UE is |
| | only allowed to access CAG cells. |
| Insufficient UE Capabilities | The procedure can't proceed due to insufficient UE capabilities. |
| RedCap UE not supported | The action failed because target NG-RAN node does not support |
| | RedCap UE. |
| Unknown MBS Session ID | The action failed because the MBS Session ID is unknown. |
| Indicated MBS Session Area | The action failed because the none of the cells in indicated MBS |
| Information not served by the | Session Area Information served by the NG-RAN node. |
| gNB | |
| Inconsistent slice info for the | The action failed because the slice info of the multicast session is |
| session | inconsistent. |
| Misaligned association for the | |
| multicast and unicast sessions | The action failed because the Associated Unicast QoS Flow ID has |
| or flows | already been used, or the Associated Unicast QoS Flow ID is not |
| | defined, or the Associated Unicast QoS Flow ID is not released, or |
| | multiple MBS QoS flows associated to the same unicast QoS flow, |
| | or same multicast session associated to multiple PDU Sessions. |
| eRedCap UE not | The action failed because target NG-RAN node does not |
| supported | support eRedCap UE. |

Alternatively, the embodiments above related to eRedCap indication may be reflected by adding a new codepoint extra reduced capability in the existing information element in 9.3.1.228 RedCap Indication.

### 9.3.1.228 RedCap Indication

This IE may be provided by the NG-RAN node to inform that the UE indicates Reduced Capability.

| | | | | |
|---|---|---|---|---|
| | | | IE type and | |
| IE/Group Name | Presence | Range | reference | Semantics description |

| | | |
|---|---|---|
| RedCap Indication | M | ENUMERATED |
| | | (RedCap, . . . , extra |
| | | RedCap) |

Without loss of generality, below an example of implementation of the above embodiments to TS 38.473, v. 17.4.1:

### 8.7.1 Paging

### 8.7.1.1 General

The purpose of the Paging procedure may be understood to be used to provide the paging information to enable the gNB-DU to page a UE. The procedure uses non-UE associated signalling.

### 8.7.1.2 Successful Operation

FIG. 8 is a schematic diagram illustrating the Paging procedure. Successful operation, according to FIG. 8.7.1.2-1. As depicted, the first node 111, a gNB-CU, may, according to Action 301, send a PAGING message comprising the first indication to the second network node 112, gNB-DU, which may receive it according to Action 401.

The gNB-CU may initiate the procedure by sending a PAGING message.

[ . . . ]

The eRedCap Indication IE may be included in the UE Paging Capability IE in the PAGING message, and if present the gNB-DU may be required to, if supported, use it for paging of eRedCap UEs.

### 9.3.1.270 UE Paging Capability

This IE may provide the UE Paging Capability information needed for paging.

| | | | | |
|---|---|---|---|---|
| | | | | Semantics |
| IE/Group Name | Presence | Range | IE type and reference | description |

| | | | |
|---|---|---|---|
| INACTIVE State | O | ENUMERATED(supported, . . . ) | Corresponds to the |
| PO-Determination | | | inactive StatePO- |
| | | | Determination IE |
| | | | defined in TS |
| | | | 38.331 [8]. |
| RedCap Indication | O | ENUMERATED(true, . . . ) | |
| eRedCap | O | ENUMERATED(true, . . . ) | |
| Indication | | | |

Certain embodiments disclosed herein may provide one or more of the following technical advantage(s), which may be summarized as follows. A first advantage may be understood to be to allow eRedCap UE type identification in the core network for UE access, policy control and paging purposes.

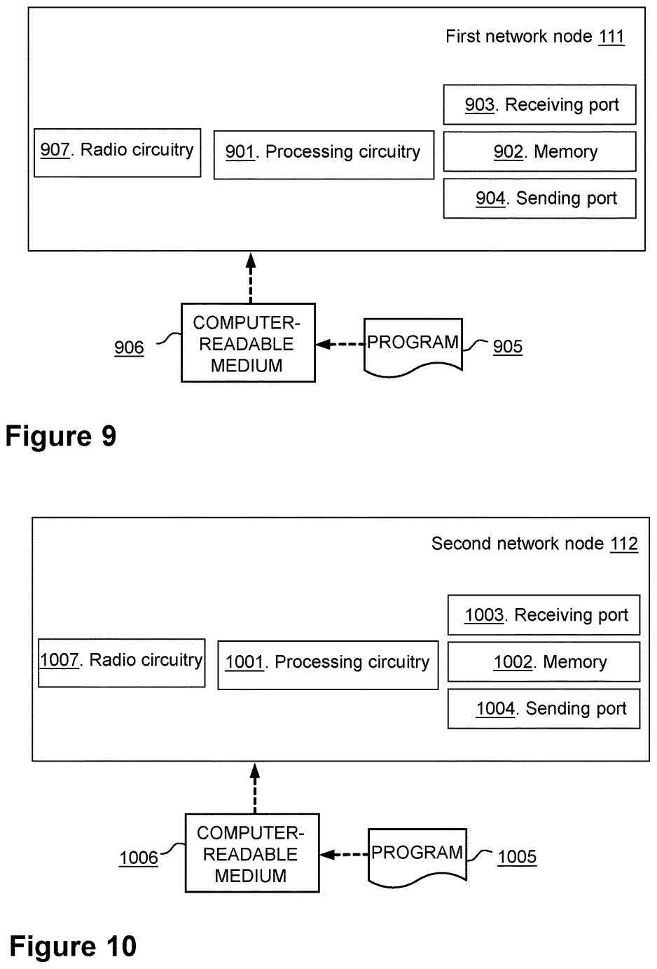

FIG. 9 depicts an example of the arrangement that the first network node 111 may comprise to perform the method actions described above in relation to FIG. 3, and/or any of FIGS. 5-8. The first network node 111 may be understood to be for handling the first indication. The first network node 111 is configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments.

The detailed description of some of the following corresponds to the same references provided above, in relation to the actions described for the first network node 111 and will thus not be repeated here to simplify the description. For example, in some embodiments, the first network node 111 may be configured to be a first radio network node, the second network node 112 may be configured to be a core network node and the source network node 113 may be configured to be a second radio network node.

In some embodiments, the first network node 111 may be configured to be an NG-RAN node, and the second network node 112 may be configured to be an AMF.

In some embodiments, the first network node 111 may be configured to be an NG-RAN node, and the second network node 112 may be configured to be an NG-eNB.

In some embodiments, the first network node 111 may be configured to be a gNB-CU and the second network node 112 may be configured to be a gNB-DU.

The first network node 111 is configured to perform the sending of Action 301, e.g. by means of a processing circuitry 901 within the first network node 111 configured to, send the first indication to the second network node 112 configured to operate in the communications network 100. The first indication is configured to indicate that the wireless device 130 is an eRedCap user equipment.

In some embodiments, the first network node 111 may be configured to be a radio network node and the second network node 112 may be configured to be a core network node, and the first indication may be configured to be sent in one of: the initial UE message, the handover request acknowledge message, and the path switch request.

In some embodiments, the first network node 111 may be configured to be an NG-RAN node and the second network node 112 may be configured to be an AMF.

In some embodiments, the first network node 111 may be configured to be a first radio network node and the second network node 112 is configured to be a second radio network node, and the first indication may be configured to be sent in the handover request acknowledge message.

In some embodiments, the first network node 111 may be configured to be an NG-RAN node and the second network node 112 may be configured to be an NG-eNB.

In some embodiments, the first indication may be configured to be sent in the handover request acknowledge message, the first network node 111 may be configured to be a target network node in a handover procedure, and the first indication may be configured to be based on the capability of the wireless device 130 configured to be obtained from the source network node 113 in the handover procedure.

In some embodiments, the handover procedure may be configured to be an inter-RAT procedure.

The first network node 111 may be configured to perform the receiving in Action 302, e.g. by means of the processing circuitry 901 within the first network node 111 configured to, receive, responsive to the sent first indication, the second indication from the second network node 112. The second indication may be configured to indicate that eRedCap user equipment is not supported.

In some embodiments, the first network node 111 may be configured to be a gNB-CU and the second network node 112 may be configured to be a gNB-DU, and the first indication may be configured to be sent in the paging message.

The embodiments herein in the first network node 111 may be implemented through one or more processors, such as a processing circuitry 901 in the first network node 111 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The processing circuitry 901 may be configured to, or operable to, perform the method actions according to FIG. 3, and/or any of FIGS. 5-8.

The first network node 111 may further comprise a memory 902 comprising one or more memory units. The memory 902 is arranged to be used to store obtained information, store data, configurations, schedulings, and applications etc. to perform the methods herein when being executed in the first network node 111.

In some embodiments, the first network node 111 may receive information from, e.g., the second network node 112, the source network node 113, the wireless device 130, and/or another structure in the communications network 100, through a receiving port 903. In some embodiments, the receiving port 903 may be, for example, connected to one or more antennas in first network node 111. Since the receiving port 903 may be in communication with the processing circuitry 901, the receiving port 903 may then send the received information to the processing circuitry 901. The receiving port 903 may also be configured to receive other information.

The processing circuitry 901 in the first network node 111 may be further configured to transmit or send information to e.g., the second network node 112, the source network node 113, the wireless device 130 and/or another structure in the communications network 100, through a sending port 904, which may be in communication with the processing circuitry 901, and the memory 902.

Those skilled in the art will also appreciate that the processing circuitry 901 described above may comprise a combination of analog and digital modules, and/or one or more processors configured with software and/or firmware, e.g., stored in memory, that, when executed by the one or more processors such as the processing circuitry 901, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the first network node 111 may be configured to perform the actions of FIG. 3, and/or any of FIGS. 5-8 with respective units that may be implemented as one or more applications running on one or more processors such as the processing circuitry 901.

Thus, the methods according to the embodiments described herein for the first network node 111 may be respectively implemented by means of a computer program 905 product, comprising instructions, i.e., software code portions, which, when executed on at least one processing circuitry 901, cause the at least one processing circuitry 901 to carry out the actions described herein, as performed by the first network node 111. The computer program 905 product may be stored on a computer-readable storage medium 906. The computer-readable storage medium 906, having stored thereon the computer program 905, may comprise instructions which, when executed on at least one processing circuitry 901, cause the at least one processing circuitry 901 to carry out the actions described herein, as performed by the first network node 111. In some embodiments, the computer-readable storage medium 906 may be a non-transitory computer-readable storage medium, such as a CD ROM disc, or a memory stick. In other embodiments, the computer program 905 product may be stored on a carrier containing the computer program 905 just described, wherein the carrier is one of an electronic signal, optical signal, radio signal, or the computer-readable storage medium 906, as described above.

The first network node 111 may comprise a communication interface configured to facilitate communications between the first network node 111 and other nodes or devices, e.g., the second network node 112, the source network node 113, the wireless device 130 and/or another structure in the communications network 100. The interface may, for example, include a transceiver configured to transmit and receive radio signals over an air interface in accordance with a suitable standard.

In other embodiments, the first network node 111 may also comprise a radio circuitry 907, which may comprise e.g., the receiving port 903 and the sending port 904. The radio circuitry 907 may be configured to set up and maintain at least a wireless connection with the second network node 112, the source network node 113, the wireless device 130 and/or another structure in the communications network 100. Circuitry may be understood herein as a hardware component.

Hence, embodiments herein also relate to the first network node 111 comprising the processing circuitry 901 and the memory 902, said memory 902 containing instructions executable by said processing circuitry 901, whereby the first network node 111 is operative to perform the actions described herein in relation to the first network node 111, e.g., in FIG. 3, and/or any of FIGS. 5-8.

FIG. 10 depicts an example of the arrangement that the second network node 112 may comprise to perform the method actions described above in relation to FIG. 4 and/or any of FIGS. 5-8. The second network node 112 is for handling the first indication. The second network node 112 is configured to operate in the communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second network node 112 and will thus not be repeated here. For example, in some embodiments, the first network node 111 may be configured to be a first radio network node, the second network node 112 may be configured to be a core network node and the source network node 113 may be configured to be a second radio network node.

In some embodiments, the first network node 111 may be configured to be an NG-RAN node, and the second network node 112 may be configured to be an AMF.

In some embodiments, the first network node 111 may be configured to be an NG-RAN node, and the second network node 112 may be configured to be an NG-eNB.

In some embodiments, the first network node 111 may be configured to be a gNB-CU and the second network node 112 may be configured to be a gNB-DU.

The second network node 112 is configured to perform the receiving of Action 401, e.g. by means of the processing circuitry 1001 within the second network node 112 configured to, receive the first indication from the first network node 111 configured to operate in the communications network 100. The first indication indicates that the wireless device 130 is an eRedCap user equipment.

In some embodiments, the first network node 111 may be configured to be a radio network node and the second network node 112 may be configured to be a core network node, and the first indication may be configured to be received in one of: the initial UE message, the handover request acknowledge message, and the path switch request.

In some embodiments, the first network node 111 may be configured to be an NG-RAN node and the second network node 112 may be configured to be an AMF.

In some embodiments, the first network node 111 may be configured to be a first radio network node and the second network node 112 may be configured to be a second radio network node, and the first indication may be configured to be received in a handover request acknowledge message.

In some embodiments, the first network node 111 may be configured to be an NG-RAN node and the second network node 112 may be configured to be an NG-eNB.

In some embodiments, the first indication may be configured to be received in the handover request acknowledge message, the first network node 111 may be configured to be a target network node in a handover procedure, and the first indication may be configured to be based on the capability of the wireless device 130 configured to originate from the source network node 113 in the handover procedure.

In some embodiments, the handover procedure may be configured to be an inter-RAT procedure.

The second network node 112 may be further configured to perform the determining of Action 402, e.g. by means of the processing circuitry 1001 within the second network node 112 configured to, determine, responsive to the received first indication, whether or not the eRedCap capability configured to be indicated is supported. The second network node 112 may be further configured to, responsive to the first indication configured to be received and based on a result of the determination, with one of the following two configurations.

The second network node 112 may be configured to perform the sending of Action 403, e.g. by means of the processing circuitry 1001 within the second network node 112 configured to, send, with the proviso the second network node 112 determines the eRedCap capability is not supported, the second indication to the first network node 111. The second indication may be configured to indicate that the eRedCap capability is not supported.

The second network node 112 may be configured to perform the initiating of Action 404, e.g. by means of the processing circuitry 1001 within the second network node 112 configured to, initiate, with the proviso the second network node 112 determines the eRedCap capability is supported, usage of the first indication in the value configured to indicate the RAT type, to identify the RAT type of the wireless device 130.

In some embodiments, the value configured to indicate the RAT type may be a new value.

In some embodiments, the first network node 111 may be configured to be a gNB-CU, and the second network node 112 may be configured to be a gNB-DU, and the first indication may be configured to be received in a paging message.

The embodiments herein in the second network node 112 may be implemented through one or more processors, such as a processing circuitry 1001 in the second network node 112 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second network node 112. One such carrier may be in the form of a CD ROM disc. It is however feasible with other data carriers such as a memory stick. The computer program code may furthermore be provided as pure program code on a server and downloaded to the second network node 112.

The processing circuitry 1001 may be configured to, or operable to, perform the method actions according to FIG. 4 and/or any of FIGS. 5-8.

The second network node 112 may further comprise a memory 1002 comprising one or more memory units. The memory 1002 is arranged to be used to store obtained information, store data, configurations, schedulings, and applications etc. to perform the methods herein when being executed in the second network node 112.

In some embodiments, the second network node 112 may receive information from, e.g., the first network node 111, the source network node 113, the wireless device 130 and/or another structure in the communications network 100, through a receiving port 1003. In some embodiments, the receiving port 1003 may be, for example, connected to one or more antennas in second network node 112. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the second network node 112 may be further configured to transmit or send information to e.g., the first network node 111, the source network node 113, the wireless device 130 and/or another structure in the communications network 100, through a sending port 1004, which may be in communication with the processing circuitry 1001, and the memory 1002.

Those skilled in the art will also appreciate that the processing circuitry 1001 described above may comprise a combination of analog and digital modules, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the second network node 112 may be configured to perform the actions of FIG. 4 and/or any of FIGS. 5-8 with respective units that may be implemented as one or more applications running on one or more processors such as the processing circuitry 1001.

Thus, the methods according to the embodiments described herein for the second network node 112 may be respectively implemented by means of a computer program 1005 product, comprising instructions, i.e., software code portions, which, when executed on at least one processing circuitry 1001, cause the at least one processing circuitry 1001 to carry out the actions described herein, as performed by the second network node 112. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the second network node 112. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The second network node 112 may comprise a communication interface configured to facilitate communications between the second network node 112 and other nodes or devices, e.g., the first network node 111, the source network node 113, the wireless device 130 and/or another structure in the communications network 100. The interface may, for example, include a transceiver configured to transmit and receive radio signals over an air interface in accordance with a suitable standard.

In other embodiments, the second network node 112 may also comprise a radio circuitry 1007, which may comprise e.g., the receiving port 1003 and the sending port 1004.

The radio circuitry 1007 may be configured to set up and maintain at least a wireless connection with the first network node 111, the source network node 113, the wireless device 130 and/or another structure in the communications network 100. Circuitry may be understood herein as a hardware component.

Hence, embodiments herein also relate to the second network node 112 comprising the processing circuitry 1001 and the memory 1002, said memory 1002 containing instructions executable by said processing circuitry 1001, whereby the second network node 112 is operative to perform the actions described herein in relation to the second network node 112, e.g., in FIG. 4 and/or any of FIGS. 5-8.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

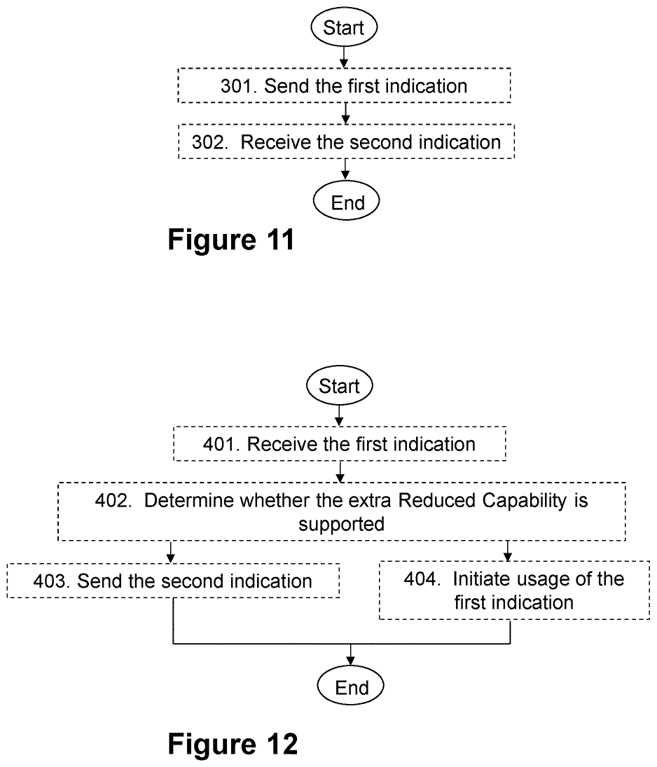

The following are examples related to embodiments herein. Any of the features described in relation to FIGS. 11-12 may be combined with the actions of the examples related to embodiments herein, described in relation to FIGS. 3-10.

The first network node examples relate to FIG. 11, FIGS. 5-8, FIG. 9 and FIG. 13, FIG. 15 and FIG. 18.

A method, performed by a first network node, such as the first network node 111, is described herein. The method may be understood to be for handling a first indication The first network node 111 may operate in the communications network 100.

Several examples are comprised herein. In some examples all the actions may be performed. In some examples, one or more actions may be performed. In particular examples of examples herein, Action 301 may be performed. It should be noted that the examples herein are not mutually exclusive. One or more examples may be combined, where applicable. All possible combinations are not described to simplify the description. Components from one embodiment may be tacitly assumed to be present in another embodiment and it will be obvious to a person skilled in the art how those components may be used in the other exemplary examples. A non-limiting example of the method performed by the first network node 111 is depicted in FIG. 11.

In some examples, the first network node 111 may be a first radio network node, the second network node 112 may be a core network node and the source network node 113 may be a second radio network node.

In some examples, the first network node 111 may be an NG-RAN node, and the second network node 112 may be an AMF.

In some examples, the first network node 111 may be an NG-RAN node, and the second network node 112 may be an NG-eNB.

In some examples, the first network node 111 may be a gNB-CU and the second network node 112 may be a gNB-DU.
Sending 301 a first indication. The first network node 111 may be configured to perform the sending of this Action 301.

The sending in this Action 301 may be to the second network node 112 operating in the communications network 100, e.g., via the first link 141.

The first indication may indicate that the wireless device 130 served by the first network node 111 indicates an extra reduced capability in comparison with first wireless devices in a first group of wireless devices 131 operating in the communications network 100. The first group of wireless devices 131 may have reduced capability in further comparison with second wireless devices in a second group of wireless devices 132 operating in the communications network 100.

In some examples, the first indication may indicate the wireless device 130 is an eRedCap user equipment.

In some examples, the first network node 111 may be a radio network node and the second network node 112 may be a core network node. In some of such examples, the first indication may be sent in one of: an initial UE message, a handover request acknowledge message, and a path switch request.

In some examples, e.g., in some of such examples, the first network node 111 may be an NG-RAN node and the second network node 112 may be an AMF.

In some examples, the first network node 111 may be a first radio network node and the second network node 112 may be a second radio network node. In some of such examples, the first indication may be sent in a handover request acknowledge message. In some examples, e.g., some of such examples, the first network node 111 may be an NG-RAN, node and the second network node 112 may be an NG-eNB.

In some examples wherein the first indication may be sent in the handover request acknowledge message, the first network node 111 may be a target network node in a handover procedure. In some examples, e.g., some of such examples, the first indication may be based on a capability of the wireless device 130 obtained from the source network node 113 in the handover procedure.

In some examples, the handover procedure may be an inter-RAT procedure.

In some examples, the first network node 111 may be a gNB-CU, and the second network node 112 may be a gNB-DU. In some examples, e.g., some of such examples, the first indication may be sent in a paging message.

In some examples, the method may comprise the following action:
Receiving 302 a second indication. The first network node 111 may be configured to perform the receiving in this Action 302.

The receiving in this Action 302 may be from the second network node 112, e.g., via the first link 141.

The second indication may indicate that the extra reduced capability is not supported.

The receiving in this Action 302 may be responsive to the sent first indication.

The first network node 111 may then send the second indication to the source network node 113, e.g., via the third link 143.

Examples of these actions and the messages and indications are provided later in this document.

The first network node 111 may also be configured to communicate user data with a host application unit in a host computer 1802, e.g., via another link such as 1860.

In FIG. 9, optional units are indicated with dashed boxes.

The first network node 111 may comprise an arrangement as shown in FIG. 9 or in FIG. 15.

The second network node examples relate to FIG. 12, FIGS. 5-8, FIG. 10 and FIG. 13, FIG. 15 and FIG. 18.

A method, performed by a second network node, such as the second network node 112, is described herein. The method may be understood to be for handling the first indication. The second network node 112 may operate in the communications network 100.

Several examples are comprised herein. In some examples all the actions may be performed. In some examples, one or more actions may be performed. In particular examples of examples herein, Action 401 may be performed. It should be noted that the examples herein are not mutually exclusive. One or more examples may be combined, where applicable. All possible combinations are not described to simplify the description. Components from one embodiment may be tacitly assumed to be present in another embodiment and it will be obvious to a person skilled in the art how those components may be used in the other exemplary examples. A non-limiting example of the method performed by the second network node 112 is depicted in FIG. 12. The detailed description of some of the following corresponds to the same references provided above, in relation to the actions described for the first network node 111 and will thus not be repeated here to simplify the description. For example, in some examples, the first network node 111 may be a first radio network node, the second network node 112 may be a core network node and the source network node 113 may be a second radio network node.

In some examples, the first network node 111 may be an NG-RAN node, and the second network node 112 may be an AMF.

In some examples, the first network node 111 may be an NG-RAN node, and the second network node 112 may be an NG-eNB.

In some examples, the first network node 111 may be a gNB-CU and the second network node 112 may be a gNB-DU.
Receiving 401 the first indication. The second network node 112 may be configured to perform the receiving of this Action 401.

The receiving in this Action 401 may be from the first network node 111 operating in the communications network 100, e.g., via the first link 141.

The first indication may indicate that the wireless device 130 served by the first network node 111 has indicated an extra reduced capability in comparison with the first wireless devices in the first group of wireless devices 131 operating in the communications network 100. The first group of wireless devices 131 may have reduced capability in further comparison with the second wireless devices in the second group of wireless devices 132 operating in the communications network 100.

In some examples, the first indication may indicate the wireless device 130 is an eRedCap user equipment.

In some examples, the first network node 111 may be a radio network node and the second network node 112 may be a core network node. In some of such examples, the first indication may be received in one of: the initial UE message, the handover request acknowledge message, and the path switch request.

In some examples, e.g., in some of such examples, the first network node 111 may be an NG-RAN node and the second network node 112 may be an AMF.

In some examples, the first network node 111 may be a first radio network node and the second network node 112 may be a second radio network node. In some of such examples, the first indication may be received in the handover request acknowledge message. In some examples, e.g., some of such examples, the first network node 111 may be an NG-RAN, node and the second network node 112 may be an NG-eNB.

In some examples wherein the first indication may be sent in the handover request acknowledge message, the first network node 111 may be the target network node in a handover procedure. In some examples, e.g., some of such examples, the first indication may be based on the capability of the wireless device 130 originating from the source network node 113 in the handover procedure.

In some examples, the handover procedure may be an inter-RAT procedure.

In some examples, the first network node 111 may be a gNB-CU, and the second network node 112 may be a gNB-DU. In some examples, e.g., some of such examples, the first indication may be sent in a paging message.

In some examples, the method may comprise one or more of the following actions:
Determining 402 whether or not the indicated extra reduced capability is supported. The second network node 112 may be configured to perform the determining of this Action 402.

Determining may be understood as calculating, deriving, selecting or similar.

The determining in this Action 402 may be responsive to the received first indication.

In some examples, the method may further comprise, responsive to the received first indication and based on a result of the determination, one of the following actions:
Sending 403 the second indication. The second network node 112 may be configured to perform the sending of this Action 403.

The sending in this Action 403 may be to the first network node 111, e.g., via the first link 141.

The second indication may indicate that the extra reduced capability is not supported.

The sending in this Action 403 may be with the proviso the second network node 112 may determine the extra reduced capability is not supported.
Initiating 404 usage of the first indication. The second network node 112 may be configured to perform the initiating of this Action 404.

Examples of these actions and the messages and indications are provided later in this document.

Initiating may be understood as triggering, enabling, starting or facilitating.

The initiating in this Action 404 may be with the proviso the second network node 112 may determine the extra reduced capability is supported.

In some examples, the usage of the first indication may be in a value indicating a RAT type. The usage of the first indication in the value may be to identify the RAT type of the wireless device 130

In some examples, the value indicating the RAT type may be a new value.

In other examples, the value indicating the RAT type may be an existing value.

Examples of these actions and the messages and indications are provided later in this document.

The second network node 112 may also be configured to communicate user data with a host application unit in a host computer 1802, e.g., via another link such as 1860.

In FIG. 10, optional units are indicated with dashed boxes.

The second network node 112 may comprise an arrangement as shown in FIG. 10 or in FIG. 15.

Selected examples related to embodiments herein

EXAMPLE 1. A method performed by a first network node (111), the method being for handling a first indication, the first network node (111) operating in a communications network (100), and the method comprising:
sending (301) a first indication to a second network node (112) operating in the communications network (100), the first indication indicating that a wireless device (130) served by the first network node (111) indicates an extra reduced capability in comparison with first wireless devices in a first group of wireless devices (131) operating in the communications network (100), the first group of wireless devices (131) having reduced capability in further comparison with second wireless devices in a second group of wireless devices (132) operating in the communications network (100).

EXAMPLE 2. The method according to example 1, wherein the first network node (111) is a radio network node and the second network node (112) is a core network node, and wherein the first indication is sent in one of:
an initial UE message,
a handover request acknowledge message, and
a path switch request.

EXAMPLE 3. The method according to example 2, wherein the first network node (111) is a New Generation, NG, -Radio Access Network, RAN, node and the second network node (112) is an Access and Mobility Management function, AMF.

EXAMPLE 4. The method according to example 1, wherein the first network node (111) is a first radio network node and the second network node (112) is a second radio network node, and wherein the first indication is sent in a handover request acknowledge message.

EXAMPLE 5. The method according to example 4, wherein the first network node (111) is a New Generation Radio Access Network, NG-RAN, node and the second network node (112) is an NG-eNB.

EXAMPLE 6. The method according to any of examples 2-5, wherein the first indication is sent in the handover request acknowledge message, wherein the first network node (111) is a target network node in a handover procedure, and wherein the first indication is based on a capability of the wireless device (130) obtained from a source network node (113) in the handover procedure.

EXAMPLE 7. The method according to example 6, wherein the handover procedure is an inter-Radio Access Technology, RAT, procedure.

EXAMPLE 8. The method according to any of examples 1-7, further comprising:
receiving (302), responsive to the sent first indication, a second indication from the second network node (112), the second indication indicating that the extra reduced capability is not supported.

EXAMPLE 9. The method according to example 1, wherein the first network node (111) is a gNode B Centralized Unit, gNB-CU, and the second network node (112) is a gNode B Distributed Unit, gNB-DU, and wherein the first indication is sent in a paging message.

EXAMPLE 10. The method according to any of examples 1-9, wherein the first indication indicates the wireless device (130) is an eRedCap user equipment.

EXAMPLE 11. A method performed by a second network node (112), the method being for handling a first indication, the second network node (112) operating in a communications network (100), and the method comprising:
receiving (401) a first indication from a first network node (111) operating in the communications network (100), the first indication indicating that a wireless device (130) served by the first network node (111) has indicated an extra reduced capability in comparison with first wireless devices in a first group of wireless devices (131) operating in the communications network (100), the first group of wireless devices (131) having reduced capability in further comparison with second wireless devices in a second group of wireless devices (132) operating in the communications network (100).

EXAMPLE 12. The method according to example 11, wherein the first network node (111) is a radio network node and the second network node (112) is a core network node, and wherein the first indication is received in one of:
an initial UE message,
a handover request acknowledge message, and
a path switch request.

EXAMPLE 13. The method according to example 12, wherein the first network node (111) is a New Generation, NG, -Radio Access Network, RAN, node and the second network node (112) is an Access and Mobility Management function, AMF.

EXAMPLE 14. The method according to example 11, wherein the first network node (111) is a first radio network node and the second network node (112) is a second radio network node, and wherein the first indication is received in a handover request acknowledge message.

EXAMPLE 15. The method according to example 14, wherein the first network node (111) is a New Generation Radio Access Network, NG-RAN, node and the second network node (112) is an NG-eNB.

EXAMPLE 16. The method according to any of examples 12-15, wherein the first indication is received in the handover request acknowledge message, wherein the first network node (111) is a target network node in a handover procedure, and wherein the first indication is based on a capability of the wireless device (130) originating from a source network node (113) in the handover procedure.

EXAMPLE 17. The method according to example 16, wherein the handover procedure is an inter-Radio Access Technology, RAT, procedure.

EXAMPLE 18. The method according to any of examples 11-17, further comprising:
determining (402), responsive to the received first indication, whether or not the indicated extra reduced capability is supported, and wherein the method further comprises, responsive to the received first indication and based on a result of the determination, one of:
sending (403), with the proviso the second network node (112) determines the extra reduced capability is not supported, a second indication to the first network node (111), the second indication indicating that the extra reduced capability is not supported, and
initiating (404), with the proviso the second network node (112) determines the extra reduced capability is supported, usage of the first indication in a value indicating a Radio Access Technology, RAT type, to identify the RAT type of the wireless device (130).

EXAMPLE 19. The method according to example 18, wherein the value indicating the RAT type is a new value.

EXAMPLE 20. The method according to example 11, wherein the first network node (111) is a gNode B Centralized Unit, gNB-CU, and the second network node (112) is a gNode B Distributed Unit, gNB-DU, and wherein the first indication is received in a paging message.

EXAMPLE 21. The method according to any of examples 11-20, wherein the first indication indicates the wireless device (130) is an eRedCap user equipment.

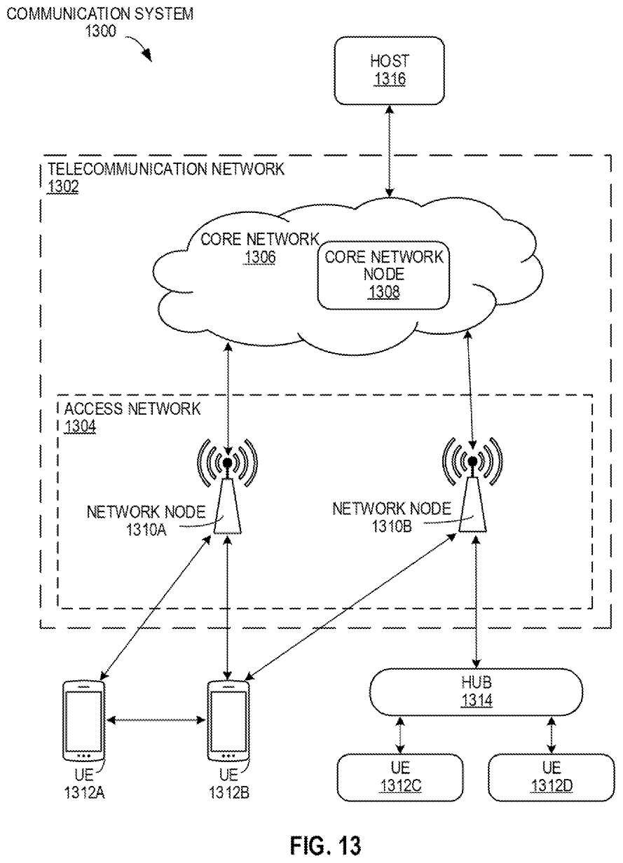

Further Extensions and Variations FIG. 13 shows an example of a communication system 1300 in accordance with some embodiments.

In the example, the communication system 1300, such as the communications network 100, includes a telecommunication network 1302 that includes an access network 1304, such as a radio access network (RAN), and a core network 1306, which includes one or more core network nodes 1308. The access network 1304 includes one or more access network nodes, such as the first network node 111 and the second network node 112. For example, network nodes 1310a and 1310b (one or more of which may be generally referred to as network nodes 1310), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1302 includes one or more Open-RAN (ORAN) network nodes. An ORAN network node is a node in the telecommunication network 1302 that supports an ORAN specification (e.g., a specification published by the O-RAN Alliance, or any similar organization) and may operate alone or together with other nodes to implement one or more functionalities of any node in the telecommunication network 1302, including one or more network nodes 1310 and/or core network nodes 1308.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized.

For example, the virtualization environment may include an O-Cloud computing platform orchestrated by a Service Management and Orchestration Framework via an O-2 interface defined by the O-RAN Alliance or comparable technologies. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections. Any of the UEs 1312a, 1312b, 1312c, and 1312d are examples of the wireless device 130.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The wireless device 130, exemplified in FIG. 13 as the UEs 1312 may be any of a wide variety of communication devices, including wireless devices arranged, configured, and/or operable to communicate wirelessly with the first network node 111 and the second network node 112, exemplified in FIG. 13 as network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub—that is, a hub whose primary function is to route communications to/from the UEs from/to the network node 1310b. In other embodiments, the hub 1314 may be a non-dedicated hub—that is, a device which is capable of operating to route communications between the UEs and network node 1310b, but which is additionally capable of operating as a communication start and/or end point for certain data channels.

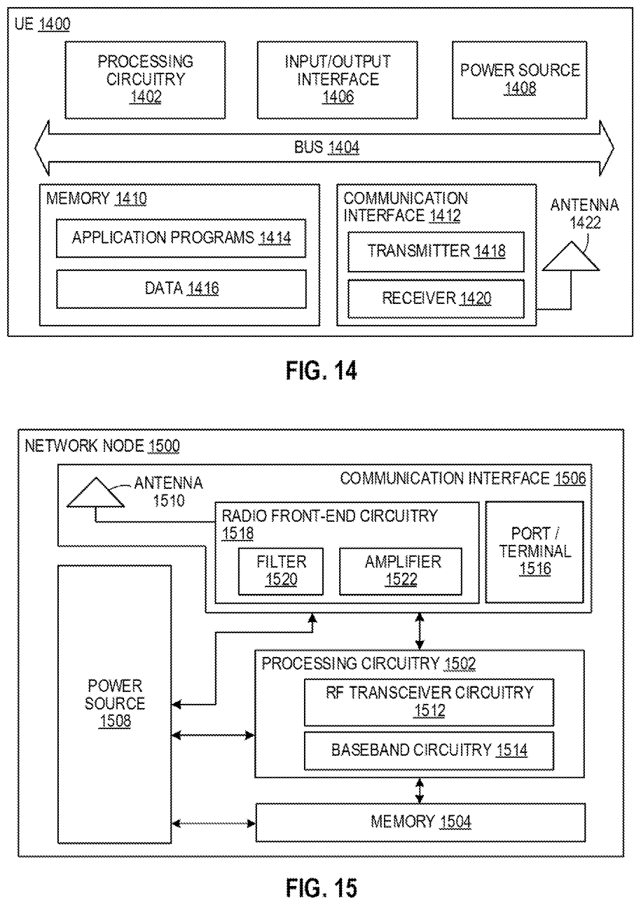

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510. Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment. Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

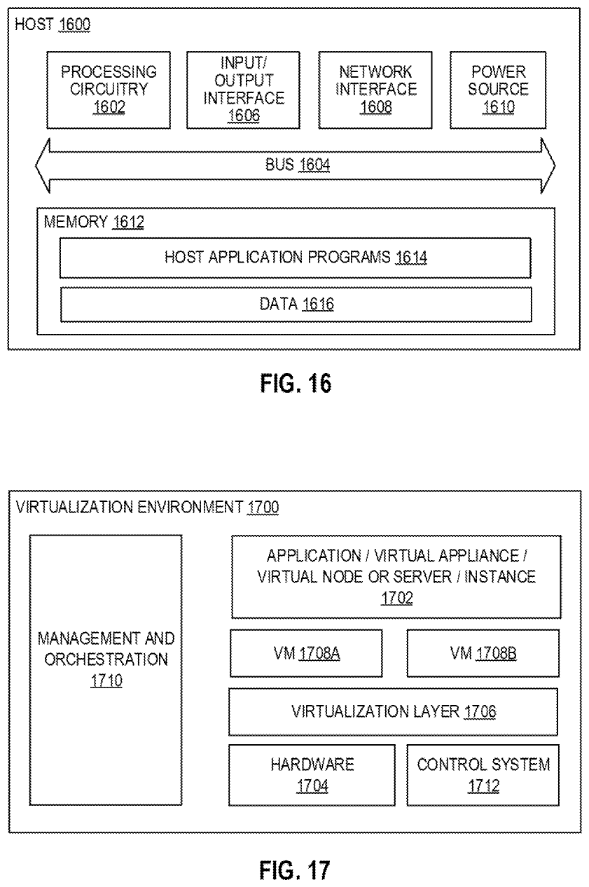

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1700 includes components defined by the O-RAN Alliance, such as an O-Cloud environment orchestrated by a Service Management and Orchestration Framework via an O-2 interface.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine. Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization. Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

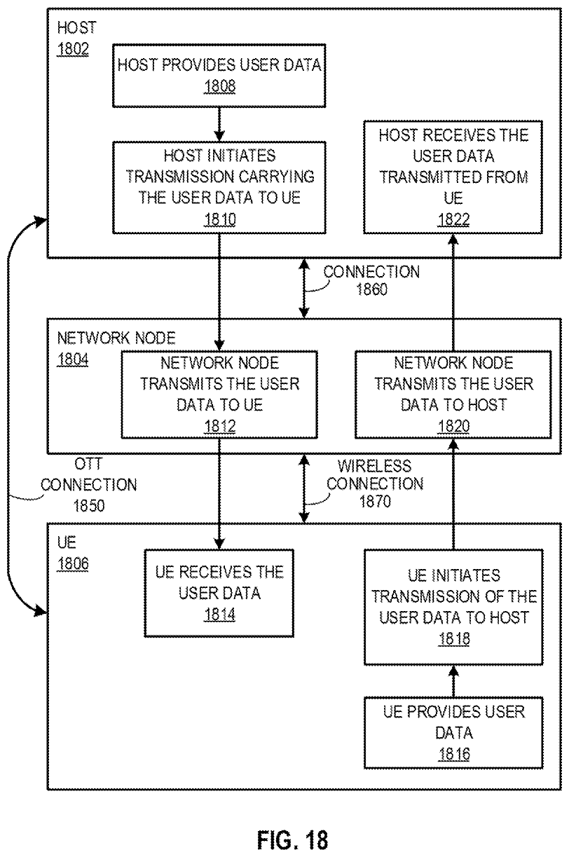

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The first network node embodiments relate to FIG. 3, FIGS. 5-8, FIG. 9 and FIG. 13, FIG. 15 and FIG. 18.

The first network node 111 may also be configured to communicate user data with a host application unit in a host computer 1802, e.g., via another link such as 1860.

The first network node 111 may comprise an arrangement as shown in FIG. 9 or in FIG. 15.

The second network node embodiments relate to FIG. 4, FIGS. 5-8, FIG. 10 and FIG. 13, FIG. 15 and FIG. 18.

The second network node 112 may also be configured to communicate user data with a host application unit in a host computer 1802, e.g., via another link such as 1860.

The second network node 112 may comprise an arrangement as shown in FIG. 10 or in FIG. 15.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by any of the first network node 111 and the second network node 112.

2. The host of the previous embodiment, wherein:
the processing circuitry of the host is configured to execute a host application that provides the user data; and
the UE comprises processing circuitry configured to execute a client application associated with the host application to receive the transmission of user data from the host.

3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by any of the first network node 111 and the second network node 112.

4. The method of the previous embodiment, further comprising, at the network node, transmitting the user data provided by the host for the UE.

5. The method of any of the previous 2 embodiments, wherein the user data is provided at the host by executing a host application that interacts with a client application executing on the UE, the client application being associated with the host application.

6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by any of the first network node 111 and the second network node 112.

7. The communication system of the previous embodiment, further comprising:
the network node; and/or
the user equipment.

8. The communication system of the previous 2 embodiments, wherein:
the processing circuitry of the host is configured to execute a host application, thereby providing the user data; and
the host application is configured to interact with a client application executing on the UE, the client application being associated with the host application.

9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by any of the first network node 111 and the second network node 112.

10. The host of the previous 2 embodiments, wherein:
the processing circuitry of the host is configured to execute a host application, thereby providing the user data; and
the host application is configured to interact with a client application executing on the UE, the client application being associated with the host application.

11. The host of the any of the previous 2 embodiments, wherein the initiating receipt of the user data comprises requesting the user data.

12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by any of the first network node 111 and the second network node 112.

13. The method of the previous embodiment, further comprising at the network node, transmitting the received user data to the host.

### REFERENCES

1. TS 38.413 https://www.3gpp.org/ftp/Specs/archive/38_series/38.413/38413-h40.zip
2. TS 38.473 https://www.3gpp.org/ftp/Specs/archive/38_series/38.473/38473-h41.zip

1. A method performed by a first network node for handling a first indication, wherein the first network node operates in a communications network, the method comprising:
sending the first indication to a second network node operating in the communications network, the first indication indicating that a wireless device is an enhanced Reduced Capability (eRedCap) user equipment.

2. The method according to claim 1, wherein the first network node is a radio network node and the second network node is a core network node, and wherein the first indication is sent in one of:
an initial UE message,
a handover request acknowledge message, and
a path switch request.

3. The method according to claim 2, wherein the first network node is a New Generation (NG)-Radio Access Network (RAN) node and the second network node is an Access and Mobility Management function (AMF).

4. The method according to claim 1, wherein the first network node is a first radio network node and the second network node is a second radio network node, and wherein the first indication is sent in a handover request acknowledge message.

5. The method according to claim 4, wherein the first network node is a New Generation Radio Access Network NG-RAN node and the second network node is an NG-evolved NodeB (eNB).

6. The method according to claim 2, wherein the first indication is sent in the handover request acknowledge message, wherein the first network node is a target network node in a handover procedure, and wherein the first indication is based on a capability of the wireless device obtained from a source network node in the handover procedure.

7. The method according to claim 6, wherein the handover procedure is an inter-Radio Access Technology (RAT) procedure.

8. The method according to claim 1, further comprising:
receiving, responsive to sending the first indication, a second indication from the second network node, the second indication indicating that eRedCap user equipment is not supported.

9. The method according to claim 1, wherein the first network node is a gNode B Centralized Unit (gNB-CU) and the second network node is a gNode B Distributed Unit (gNB-DU) and wherein the first indication is sent in a paging message.

10. A method performed by a second network node for handling a first indication, wherein the second network node operates in a communications network, the method comprising:
receiving the first indication from a first network node operating in the communications network, the first indication indicating that a wireless device is an enhanced Reduced Capability (eRedCap) user equipment.

11. The method according to claim 10, wherein the first network node is a radio network node and the second network node is a core network node, and wherein the first indication is received in one of:
an initial UE message,
a handover request acknowledge message, and
a path switch request.

12. The method according to claim 11, wherein the first network node is a New Generation (NG)-Radio Access Network (RAN) node and the second network node is an Access and Mobility Management function (AMF).

13. The method according to claim 10, wherein the first network node is a first radio network node and the second network node is a second radio network node, and wherein the first indication is received in a handover request acknowledge message.

14. The method according to claim 13, wherein the first network node is a New Generation Radio Access Network (NG-RAN) node and the second network node is an NG-evolved NodeB (eNB).

15. The method according to claim 11, wherein the first indication is received in the handover request acknowledge message, wherein the first network node is a target network node in a handover procedure, and wherein the first indication is based on a capability of the wireless device originating from a source network node in the handover procedure.

16. The method according to claim 15, wherein the handover procedure is an inter-Radio Access Technology (RAT) procedure.

17. The method according to claim 16, further comprising:
determining, responsive to receiving the first indication, whether or not the eRedCap is supported, and wherein the method further comprises, responsive to receiving the first indication and based on a result of the determining, one of:
sending, with a proviso the second network node determines the eRedCap is not supported, a second indication to the first network node, the second indication indicating that the eRedCap is not supported, and
initiating, with the proviso the second network node determines the eRedCap is supported, usage of the first indication in a value indicating a Radio Access Technology (RAT) type, to identify the RAT type of the wireless device.

18. The method according to claim 17, wherein the value indicating the RAT type is a new value.

19. The method according to claim 10, wherein the first network node is a gNode B Centralized Unit (gNB-CU) and the second network node is a gNode B Distributed Unit (gNB-DU) and wherein the first indication is received in a paging message.

20. A first network node, for handling a first indication, wherein the first network node being configured to operate in a communications network, the first network node comprising:
a processor; and
a memory comprising computer program code which, when executed by the processor, cause the first network node to:
send the first indication to a second network node configured to operate in the communications network, the first indication to indicate that a wireless device is an enhanced Reduced Capability (eRedCap) user equipment.

21. The first network node according to claim 20, wherein the first network node is a radio network node and the second network node is a core network node, and wherein the first indication is configured to be sent in one of:
an initial UE message,
a handover request acknowledge message, and
a path switch request.

22-28. (canceled)

29. A second network node, for handling a first indication,
wherein the second network node being configured to operate in a communications network, the second network node comprising:
a processor; and
a memory comprising computer program code which, when executed by the processor, cause the second network node to:
receive the first indication from a first network node configured to operate in the communications network, the first indication is configured to indicate that a wireless device is an enhanced Reduced Capability (eRedCap) user equipment.

30. The second network node according to claim 29, wherein the first network node is a radio network node and the second network node is a core network node, and wherein the first indication is configured to be received in one of:
an initial UE message,
a handover request acknowledge message, and
a path switch request.

31-38. (canceled)
